(19) United States
(12) Patent Application Publication
(10) Pub. No.: US 2006/0129447 A1
(43) Pub. Date: Jun. 15, 2006

(54) Methods and software arrangements for sales force effectiveness

(76) Inventors: James Daniel Dockery, Hatfield, PA (US); Paul R. Wilson, Paoli, PA (US); Timothy William Downey, Broomall, PA (US); Yilian Yuan, North Wales, PA (US); Kjell Ake Nygren, Plainsboro, NJ (US); Susan Huffman Foltz, Reinholds, PA (US)

Correspondence Address: BAKER & BOTTS, 30 ROCKEFELLER PLAZA, NEW YORK, NY, 10112, US

(21) Appl. No.: 11/013,979

(22) Filed: Dec. 16, 2004

Related U.S. Application Data
(60) Provisional application No. 60/529,592, filed on Dec. 16, 2003.

(51) Int. Cl. G06F 17/30

(52) U.S. Cl. 705/10

(57) ABSTRACT

A business planning solution for sales force effectiveness in promoting products in a target market is provided. The planning solution analyzes sales and market data to identify target market segments that are likely to respond to sales force activity. Business resources can then be allocated to optimize sales force activity. Detailed sales call plans can be generated. The business planning solution may be implemented as a computer software application on conventional stand alone or networked computer arrangements. For pharmaceutical industry applications, the software application is configured to process pharmaceutical market research data.

### CROSS REFERENCE TO RELATED APPLICATION

This application claims the benefit of U.S. provisional Patent Application No. 60/529,592 filed Dec. 16, 2003, which is hereby incorporated by reference herein in its entirety.

### BACKGROUND OF THE INVENTION

The present invention relates to methods and systems for sales management. In particular the invention relates to methods and software arrangements for analyzing sales data for optimizing sales and marketing activities.

Business entities often conduct organized sales or marketing efforts to develop markets for their products or services. The marketing campaigns may be variously conducted according to specific business concepts or strategies adopted by specific entities. The marketing campaign may, for example, include using a sales force to promote a product by introducing the product to a target population. Often the particular strategy or implementation adopted for a marketing campaign is based on tradition or mere intuition. In traditional business environments, the success or effectiveness of a marketing campaign is not known until after resources have been expended on the campaign. However now, with the widespread availability of electronic data storage and processing means, organizations can now attempt to collect current or timely market research data to monitor the real-time progress of a marketing campaign.

For example, pharmaceutical companies often develop markets for their specific products or brands in a target geography or territory by using a sales force to make contact with prescribing practitioners (e.g., physicians, doctors and nurses) in the territory. The salespersons in the sales force may, for example, call on a large number of target practitioners to introduce them to new products. The salespersons may visit or otherwise interact with the targeted practitioners to encourage continued or increased use of the marketed products and to possibly discourage use of competitor products.

A sales effort for a particular product may involve making sales calls on a selected group of practitioners on a regular schedule. The group of practitioners may be selected at random or by historical choice. The success or effectiveness of a marketing campaign for a particular product may be depend on the frequency of sales calls and on the particular practitioners contacted. Often the sales effort for a particular product is combined with sales efforts for other products marketed by the pharmaceutical company. Therefore, it is often difficult to ascribe the final sales results to a particular level of resources allocated to sales effort for a particular product particularly when the marketing campaign overlaps with the sales efforts for other products.

Consideration is now being given to systems and methods to increase sales force effectiveness for marketing particular products. In particular, attention is directed toward software arrangements for analyzing sales and marketing data to optimize resource allocations for the sales efforts for the particular products. Desirable systems and methods may provide business-planning solutions based on an evaluation of sales results by individual product and by the individuals or groups targeted for sales calls.

### SUMMARY OF THE INVENTION

In accordance with the principles of the invention, a business planning solution is provided for analysis and planning of sales and marketing activities for sales force effectiveness in promoting particular products.

The business planning solution is implemented as an interactive software arrangement. The software arrangement is configured to generate business plans for making optimal allocations of sales and marketing resources for promoting a portfolio of products. The business plans may include assessments of the financial impact of changes in resource levels and allocation. The business plans also may include assessments of a desired size of a sales force for promoting particular products, and the financial implications of the sales force sizes or levels of sales activities under different operational and market scenarios.

The software arrangement is configured to generate operational and market scenarios that include consideration of the practical constraints on the marketing and sales activities of a specific business entity.

In applications for a pharmaceutical concern, the business planning solution may provide detailed sales activity plans for sales force effectiveness in promoting products. The sales call plans may, for example, include recommendations on which products, by position, should each individual sales rep in a sales team promote to individually selected physician in the product market.

The software arrangement for the business planning solution may include suitable market segmentation and marketing mix (portfolio segmentation) models, which describe the target market. The sales call plans are developed by the software arrangement by analysis and identification of those market segments that are likely to be responsive to sales activities directed at promoting the particular products, and making optimal allocations of sales activity resources to the responsive market segments. The analysis and identification of the market segments and the resource allocations can include consideration of the market mix (i.e. overlapping marketing of a portfolio of products).

For pharmaceutical industry applications, the models which describe the market, may be based on suitable market research data, including, for example, data from databases assembled by commercial market research providers. The suitable market data may include information on the tracking of pharmaceutical product movement, buying trends, physicians' prescription patterns, doctor/patient interactions and disease treatment patterns.

The suitable market data may acquired across retail markets (e.g., Xponent, LRx, Group Practice Data, European Physician Profile Data), non-retail markets ( e.g., MII, DDD, European National/Sub National Hospital Data), and managed care markets (e.g., Plantrak, HMO Indices). The market data may include data obtained by conducting audits, panels, surveys (e.g., Integrated Promotional Services (IPS), National Disease and Therapeutic Index (NDTI), and National Prescription Audit (NPA) data).

The software arrangement for implementing the business planning solution may have suitable input and output interfaces (e.g., display screens) for interactive operation by a user. The software arrangement also may be suitably interfaced to accept market research data in electronic format from commercial databases. Similarly, the software arrangement may be suitably interfaced to a specific business entity or client's databases and files so that the business planning solution can be customized for the specific business entity's sales and marketing activities. The software arrangement can be configured to generate custom metrics and benchmarks for the specific business entity.

In one version, the software arrangement may be configured for market segmentation analysis based on pharmaceutical sales and market data including volume (deciling) data, behavioral data, and integrated segmentation data. The software arrangement may include tools and models for portfolio segmentation (e.g., optimal promotional spend for each product, while balancing other products in the portfolio ) for a mix of products promoted by a client. The software arrangement may be configured for optimization at either a physician-level or a segment level.

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is flow diagram of an exemplary method for enhancing sales force effectiveness in the marketing of a pharmaceutical product, in accordance with the principles of the present invention.

FIG. 2 is block diagram of an exemplary arrangement of software modules for analysis of sales data and for generating optimized sales plans, in accordance with the principles of the present invention.

FIGS. 3-7, 8a-8c, and 9-30 are interactive input and output screens of an exemplary tool set for implementing a business planning solution for sales force effectiveness, in accordance with the principles of the present invention.

### DESCRIPTION OF THE INVENTION

The present invention provides a business planning solution that can be used to fashion or tailor a sales campaign to achieve desired product sales and financial goals of a business entity. The business planning solution may be implemented on conventional standalone or networked computers that are commonly used by businesses. The business planning solution may be integrated or otherwise used in conjunction with other business planning and data tools.

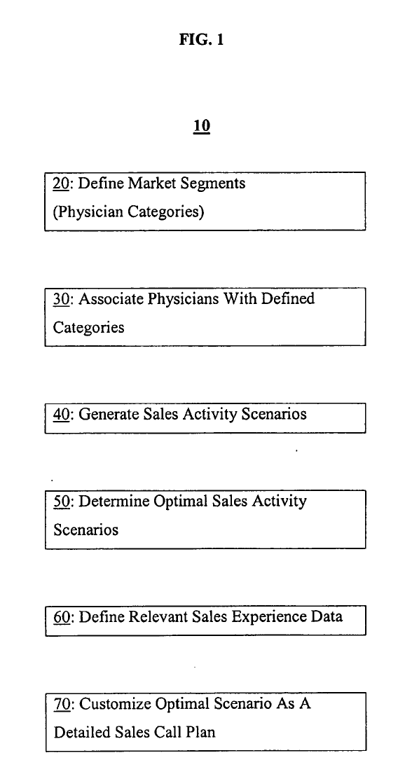

The business planning solution may be implemented or operated for a business entity (“entity”) by a provider (“provider”). The provider can be an organization internal or external to the entity. The business planning solution is based on an inventive method (See e.g., FIG. 1 method 10) for optimizing sales and marketing campaigns for particular products. The method is based on quantitative analysis of product sales data, market structure, and the characteristics of the entity marketing the product.

FIG. 1 shows the exemplary steps of a method 10 for implementing the business planning solution for optimizing a sales and marketing campaign (hereinafter “sales effort”), which may be conducted by a sales force for a particular product. The business planning solution is designed to improve the effectiveness of the sales force by directing their efforts and resources toward market segments that are most likely to respond to the sales effort. A preliminary process for directing the efforts of the sales force to responsive market segment involves suitable identification or definitions of the market segments. Suitable definitions of the market segments may be analytically derived from market response data. The market response data can be acquired “live” during the course of the sales effort or may be historical data. The market segments may be redefined during the course of the sales effort.

For purposes of illustration, an exemplary application of method 10 is described herein in the context of a sales effort for a particular pharmaceutical product. The sales effort may be based on sales force personnel calling on a target market population of physicians who, for example, are likely to use or prescribe the marketed pharmaceutical product.

With reference to FIG. 1, steps 20 and 30 relate to the definition of suitable market segments (i.e. categories of the target physician population). At step 20, several categories of physicians may be defined according to suitably selected physician characteristics. The definitions of the physician categories may be based on physician characteristics that are obtained or developed from sales data and other data. The data may include both current sales and market data and/or historical sales and market data. The data may be relevant to a predetermined period of time, for example, one year or six months. Exemplary physician characteristics on which the definitions of the several physician categories are based may include characteristics such as the physician's rate of prescribing a particular pharmaceutical product, and the volume or dosage of the particular product prescribed by the physician. Other physician characteristics that may be used to define the physician categories may refer to the increase or decrease in either the physician's rate of prescribing a product, or in the average dose prescribed by the physician. Additional physician characteristics, which are relevant for defining the physician categories, may include the rate at which a physician prescribes alternate or competing pharmaceutical products instead of the marketed pharmaceutical product. The definition of the physician categories also may be based on demographic characteristics such as the physician's medical specialty, age, gender, and the geographic location or zip code of the physician's medical practice.

At step 30, which may be performed prior to or at any time during the sales effort for the particular pharmaceutical product, each of the physicians in the target physician population is identified or associated with a named physician category defined at step 20.

At steps 40 and 50, sales effort scenarios are then generated in response to the market segmentation (i.e., categorization of the population of target physicians) at step 30. At step 40, in some scenarios select physician categories may be identified for new or continued sales calls by the sale force regarding the subject pharmaceutical product. Other physician categories may be identified as not having good prospects or returns. At step 50, an optimal or desirable schedule of sales calls regarding the particular pharmaceutical product is generated. The optimal or desirable schedule of sales calls may be designed to achieve specific sales goals. The sales calls may be directed to individual physicians in each of the select categories of physicians that are likely to be responsive to the sales campaign.

The selection of the physician categories and scheduling of the sales calls at steps 40 and 50, respectively, may be based on suitable “market response” modeling of sales experience data, which may include both ongoing and historical experience data. The sales experience data for this purpose may have been generated, for example, in the course of previous sales contacts regarding the particular pharmaceutical product. Preferably, the sales experience data includes data from sales contacts with at least some of the physicians in each of the categories of physicians. Relevant sales experience data may be collected and assembled for use on a continuous or periodic basis at step 60. Relevant sales experience data collected at step 60 may include, for example, the frequency or number of all types of sales calls, and the frequency or number of sales calls specifically regarding the particular pharmaceutical product made on each physician. The relevant sales experience data also may identify physicians who have previously purchased or prescribed the pharmaceutical product, and the frequency at which these physicians have purchased or prescribed the pharmaceutical product. Additionally, the relevant sales experience data may include volume or use data (e.g., the amount of the pharmaceutical product purchased or prescribed by each of the physicians).

The determination of the optimal or desirable schedule of sales calls at step 50 may include a determination of which of the named categories of physicians include individual physicians who should be targeted for sales calls regarding the pharmaceutical products market by the entity, and also the frequency at which these individual physicians should be contacted. The optimal frequency for contacting these individual physicians may vary by the named category with which the individual physicians are associated (at step 20 and 30). For example, a first named category of physicians may include five hundred physicians, a sample of whom (e.g., fifty) may have been previously contacted regarding the particular medical product. Based on the relevant sales experience data from the previous sales contacts with the fifty physicians, an optimal or desirable schedule of sales contacts generated at step 50 may include planned sales contacts with all of the five hundred physicians in the first named category of physicians. Similarly, a second named category of physicians may include another five hundred physicians of whom fifty may have been previously contacted regarding the particular medical product. Based on modeling of the relevant sales experience data from the previous sales contacts with these fifty physicians, an optimal or desirable schedule of sales contacts generated at step 50 may forgo sales contacts with all of the five hundred physicians in the second named category of physicians.

At step 70 of method 10, the optimal or desirable schedule of sales contacts may be customized in detail for each individual physician. For example, the customized sales contacts scheduled for an individual physician may include specific information and instructions for conducting the sales calls. The information and instructions may include information on how often the sales force should call on the individual physician, and on which marketed products (in addition to or as an alternate to the subject pharmaceutical product) should a salesperson discuss with the individual physician. The instructions or information also may include a suggested or preferred order in which the salesperson should discuss the marketed products with the individual physician.

In this manner, the efforts and resources of the sales force may be directed and brought to bear on selected market segments (i.e. physician categories) that are most likely to advance the sales goals for the particular pharmaceutical product.

The inventive business planning solution for generating an optimal or desirable schedule of sales contacts (e.g., physician calls) for improving sales force effectiveness may be implemented as a modular software arrangement on commonly used business computers and networks.

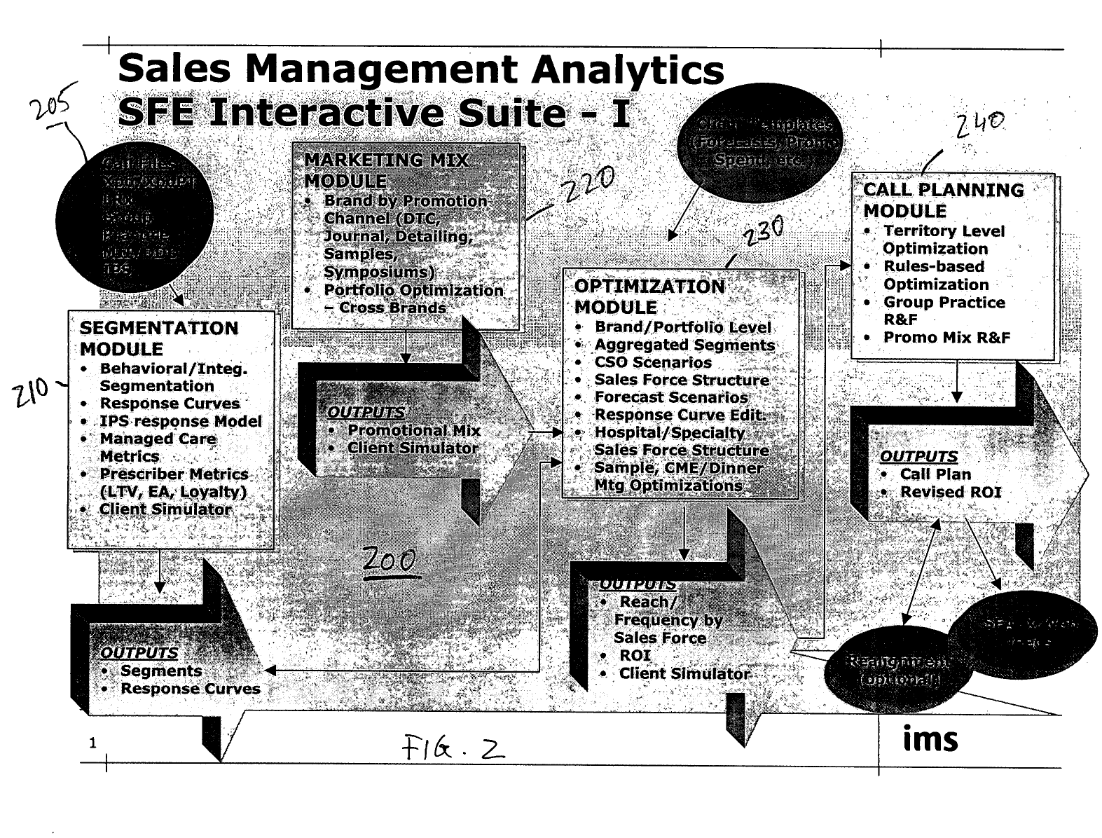

FIG. 2 shows an exemplary software arrangement 200, which is designed to optimize the sales efforts of clients for marketing one particular product or a mix of products (e.g., pharmaceutical products) to a target market group (e.g., physicians). Software arrangement 200 includes one or more linked tool sets or modules 210-240 for analyzing sales and market data. The modules may be implemented on any set of computers and computer networks which, for example, have conventional user interfaces for interactive operation at multiple levels. The user interfaces may, for example, include touch screen displays at each of modules 210-250. Software arrangement 200 may additionally include interfaces for linking the modules to other business planning tools and databases.

Software module 210 may be configured to generate suitable market segment definitions for a target market, and to generate response curves for the defined market segments. The configuration may include suitable algorithms or tools for defining market segments by their individual behavioral characteristics and/or other integrated characteristics. Module 210 may further include suitable statistical response models for generating potential response curves for each of the defined market segments. The response models may be empirical models developed by fitting prior sales and market data. The response models may be proprietary response models developed by a service provider who may provide the business planning solution for client entities. Module 210 may be configured to account for specific structural parameters, metrics or rules of the target market that may affect or constrain, for example, the pharmaceutical product prescribing habits of targeted physicians. For example, managed care metrics and prescriber metrics (such as LTV, Exclusive Agency (EA) and loyalty programs) may be accounted for by module 210. Module 210 also may include simulation software for generating response curves under different market segmentation scenarios. The simulation software may be customizable to the business characteristics and rules of a specific client.

The algorithms in module 210 for defining market segment and generating response curves may be configured to act on sales and market data (e.g., data files 215) which are relevant to particular product types and targeted markets. For pharmaceutical products, the relevant data may include physician-level data that is provided commercially by market research organizations (such as the present assignee IMS Health, Inc., who is a market research provider of physician-level data for prescription and over-the-counter pharmaceutical products). Module 210 may be configured for ETL processes (extract, transform and load) to call and process multi standard format data files generated by common software tools and databases that are utilized by the market research organization. The software tools and databases utilized by the market research organization may include, for example, market research software and databases such as Xponent®/Xponent® PlanTrak™, LRx, Group Practice MII/DDD and IPS, all of which are sold commercially by the present assignee.

The promotion of a product mix including more than one pharmaceutical product in sales campaigns conducted by entities is common. A product mix may, for example, include products that are old on the market, new on the market, or are different brands. A second optional module of software arrangement 200 (i.e. module 220) may be configured for portfolio segmentation analysis across a mix of products promoted by an entity. Module 220 may be configured to generate the product mixes for the sales effort by taking into consideration the individual promotion or marketing channel (e.g., direct to customer (DTC), journal, detailing, samples, and symposium channels) that may be used to promote individual products (brands) in the product mix. Module 220 also may be configured account for optimization of an entire portfolio of products (i.e. cross brands) marketed or sold by an entity.

Like module 210, module 220 also may include simulation software that is customizable to the specific characteristics of a client.

The outputs of module 210 (e.g., market segment definitions, and market segment response curves) and module 220 (e.g., promotional product mix, and client simulator data) are processed in an optimization module 230. Module 230 may be customizable to specific client characteristics. For this purpose, module 230 may be configured to accept data or parameters characterizing the client in the form of client templates. The client templates may include client specific information (e.g., forecasts, promotional spending budgets).

Optimization module 230 is configured to process the input data received from modules 210 and 220 using suitable optimization algorithms and models to predict sales force effort (i.e. reach and frequency) that may be required for reaching the quantitative sales and financial goals of the client. The algorithms and models may be designed to optimize sales force effort at a product brand or product portfolio level. Further, the algorithms and models may be designed to take in to account variables such as aggregated market segments, statistical CSO scenarios, and sales force structure. The algorithms and models may take into account marketing and promotional channel variables (e.g., sample, continuation medical education/dinner channels, and hospital/specialty sales force structure). A version of optimization module 230 may include a response curve editor, which can be used to interactively edit response curves that are input into module 230. Module 230 also may include suitable algorithms and models for computing return on investment (ROI) data for the sale effort under different sales activity and market scenarios.

In a next call planning module 240, the required sales force effort (i.e. reach and frequency) predicted by module 230 may be processed further to generate a detailed call plan for use by the sales force. Module 240 may include suitable algorithms that can generate call plans that are optimized, for example, at a sales territory level. Other optimizations algorithms that may be included in module 240. These algorithms can be based, for example, on considerations of sales force reach and frequency in special situations such as group practice or a promotional product mix. Rule-based algorithms may be deployed.

Module 240 also may include suitable algorithms and models for computing or revising ROI data for the sales effort by call plan.

An entity may use the call plans generated by software arrangement 200 to focus sales force resources and activity on responsive market segments (e.g., individual physicians or categories) that are identified in the call plan.

It will be understood that exemplary software arrangement 200 has been shown in FIG. 2 as a linked collection of four distinct software modules only for convenience in illustration. In practice, the tools and functions of the four modules may be integrated or combined. For example, a single module may be configured to perform the functions of both module 230 and 240. Further, it will be also be understood that any conventional computer programming languages or techniques may be used to implement the functions of software arrangement 200. The computer programming techniques may include linear and non-linear programming, and genetic algorithms. In particular, the segmentation module may, for example, use rules based segmentation and automated statistical algorithms such as K-MEANS Clustering, CHAID Analysis, and Latent Class Regression. The marketing mix module may use OLS Regression, Mixed Models, and Hierarchical Bayesian Models. The call planning module may use rules-based call planning algorithms and territory level linear programming algorithms.

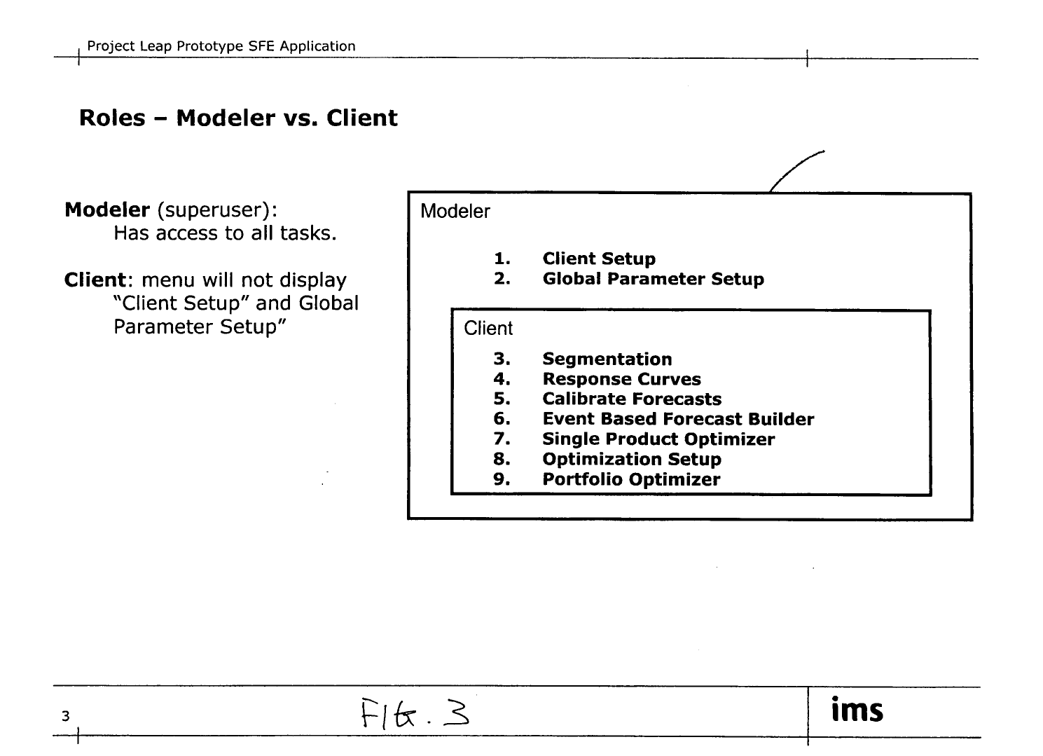

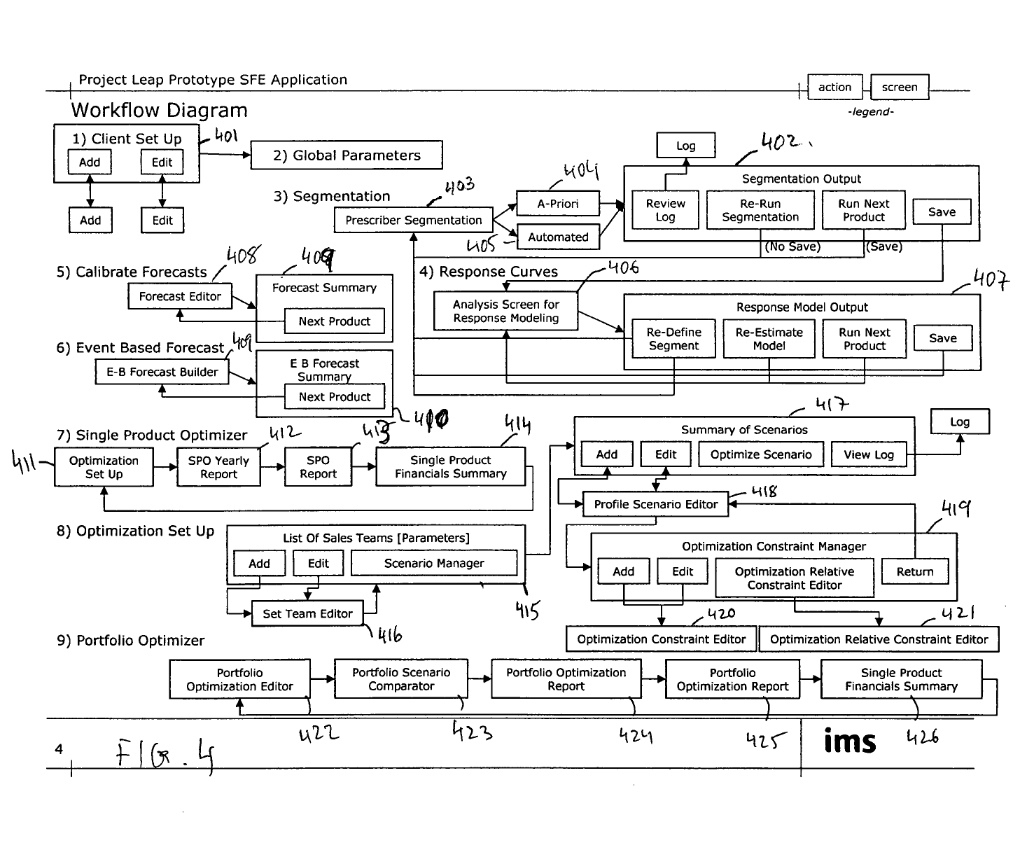

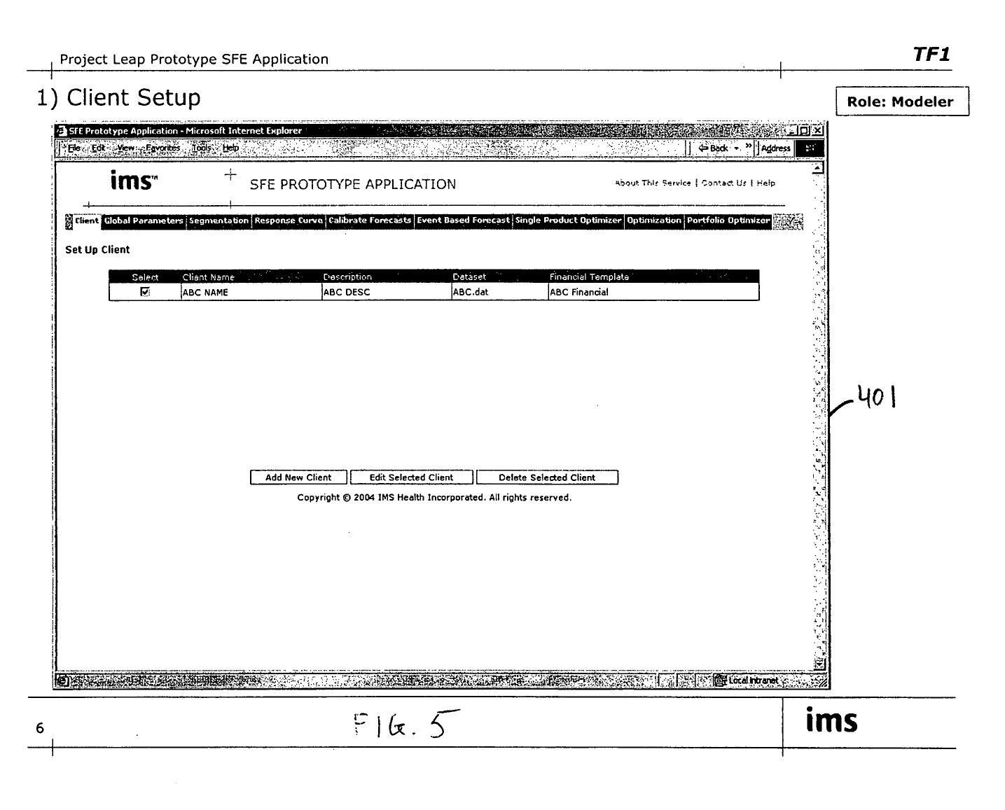

FIGS. 3 and 4 show another view on the functions or tasks that may be involved in an implementation of the business planning solution for sales force effectiveness. FIG. 3 is a schematic block diagram of a software application 300 for sales force effectiveness, in which general tasks (e.g., customizing the software application to a specific client's characteristics or parameters, and configuring a global parameters file) are accessible through a user interface (e.g., via menus on an interactive display screen) only to an administrator. The administrator may, for example, be a service provider of the business planning solution to a client. Other software application 300 tasks, for example, market segmentation, generation of response curves, calibration of forecasts, event based forecast builder, single product optimization, optimization set up and portfolio optimization, may be accessible to both the administrator and the client. Software application 300 may include a tool set (including, e.g., a prescriber segmentation tool, a response modeling tool, a forecast builder and editor tools, etc.) for performing the tasks listed in FIG. 3. The tools, models and algorithms in software application 300 may be customized for a client.

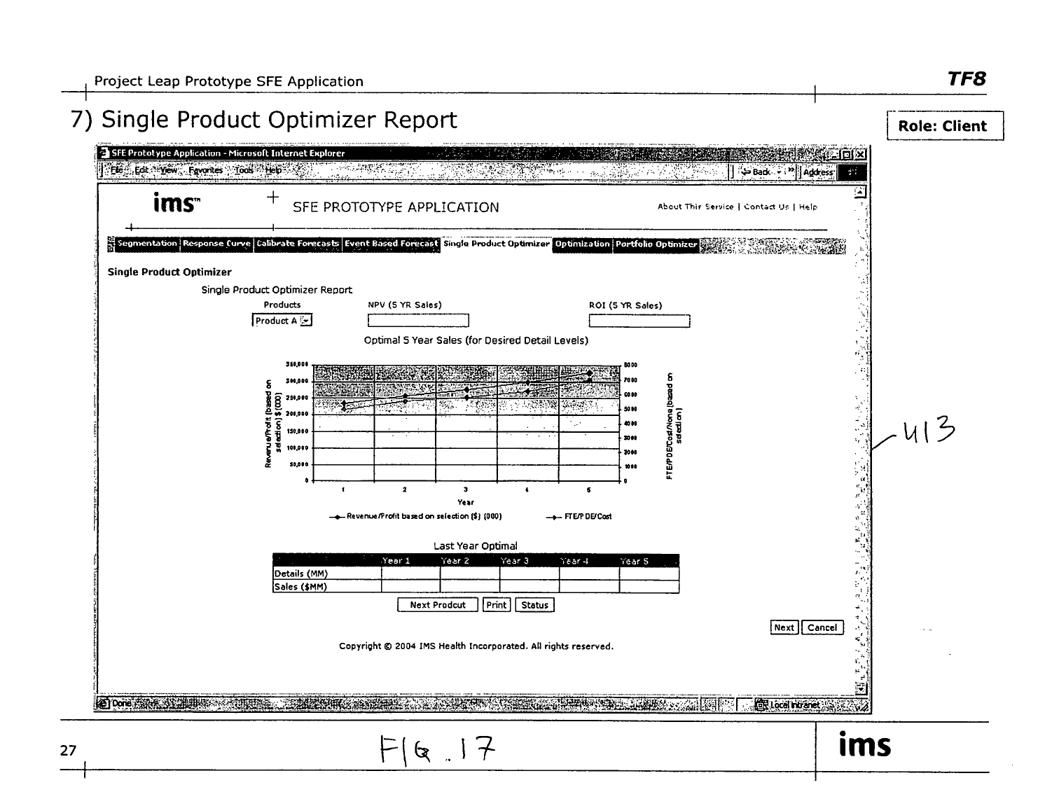

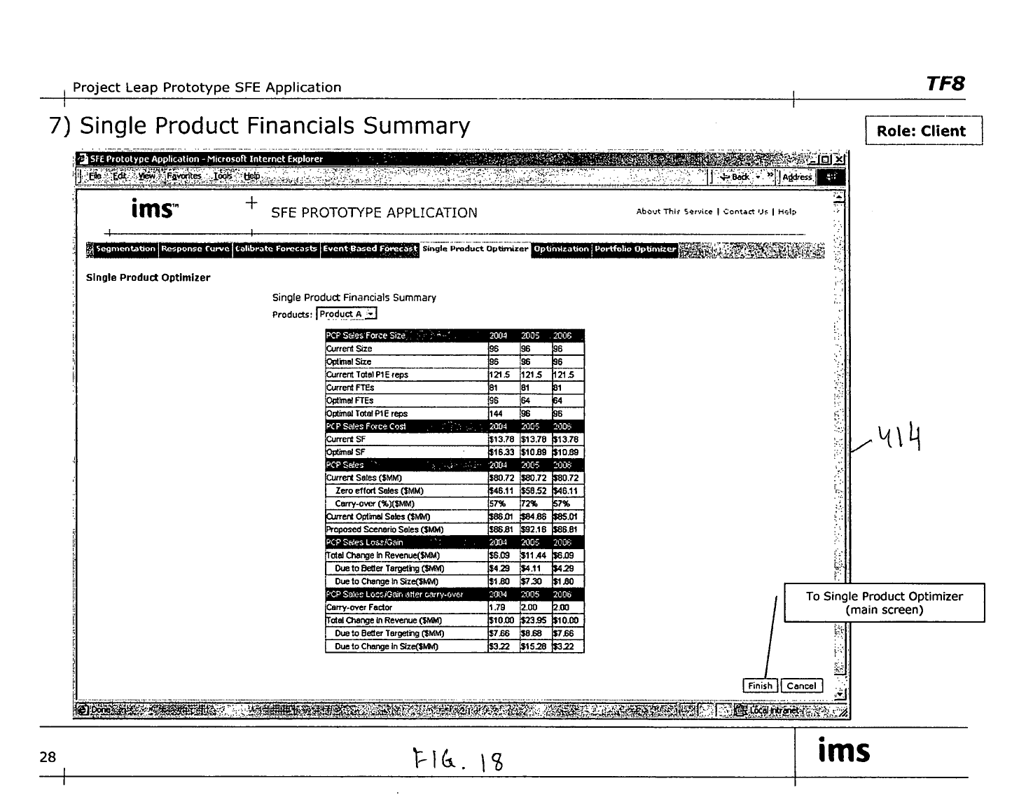

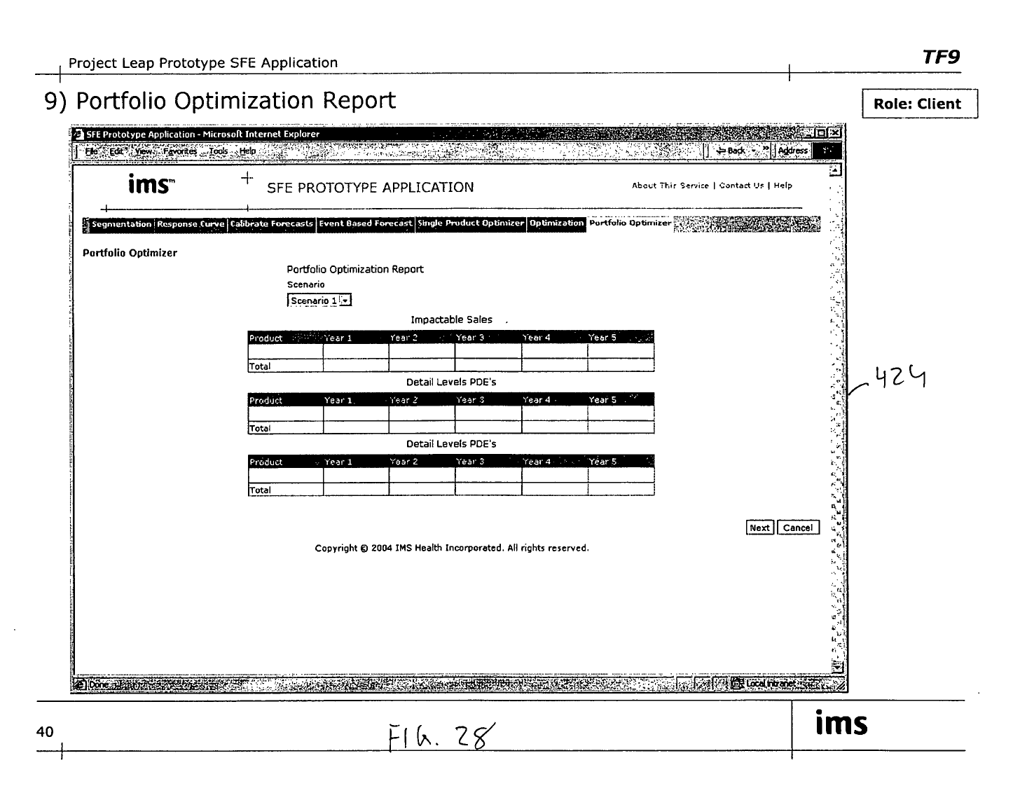

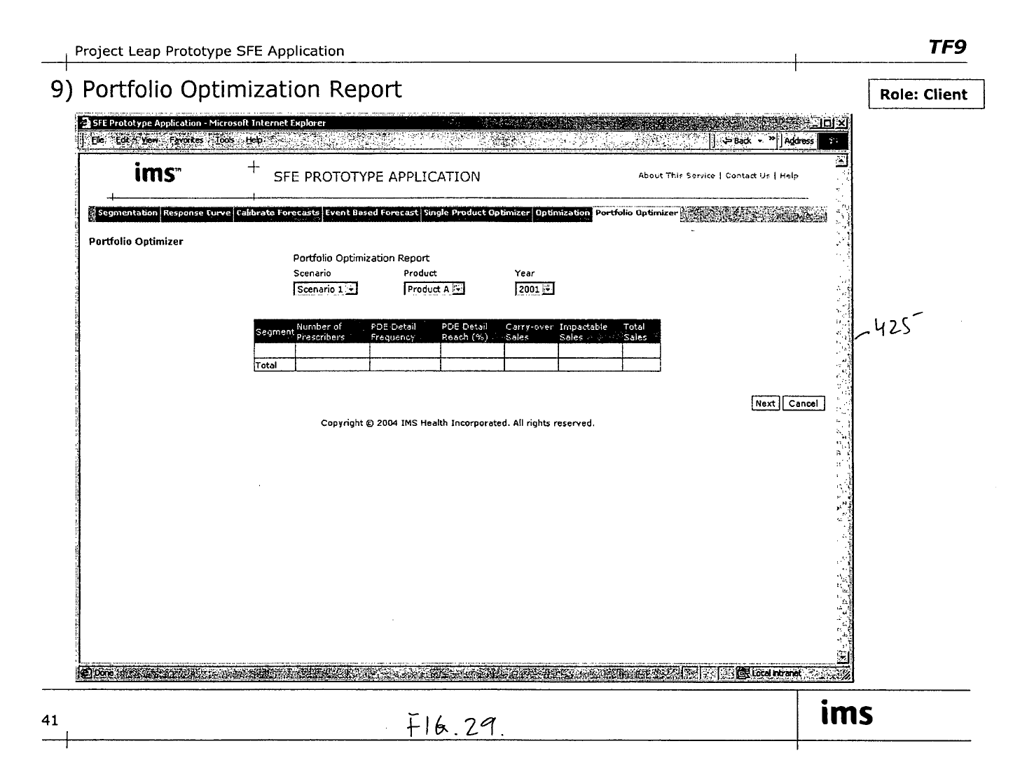

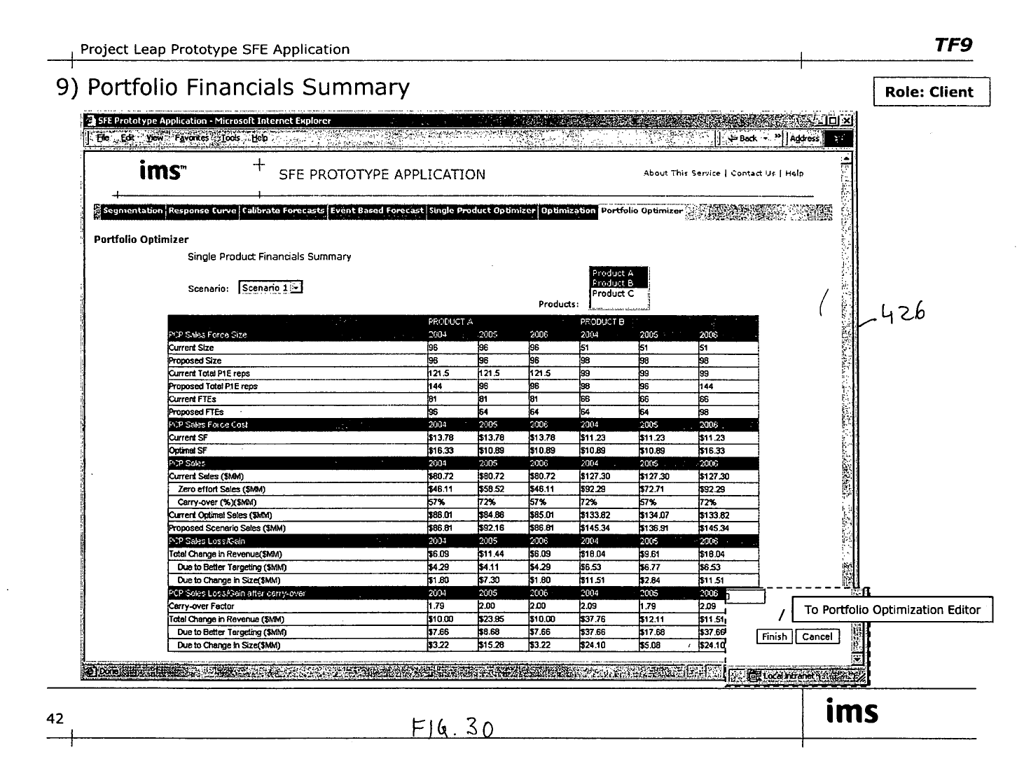

FIG. 4 is a diagram which schematically shows the processing flow in the operation of software application 300 when it is used for sales force effectiveness analysis. FIG. 4 also schematically shows interactive screen displays 401-426 that may be provided to interactive users of software application 300. Larger versions of interactive screen displays 401-426 are shown in FIGS. 5-30, respectively.

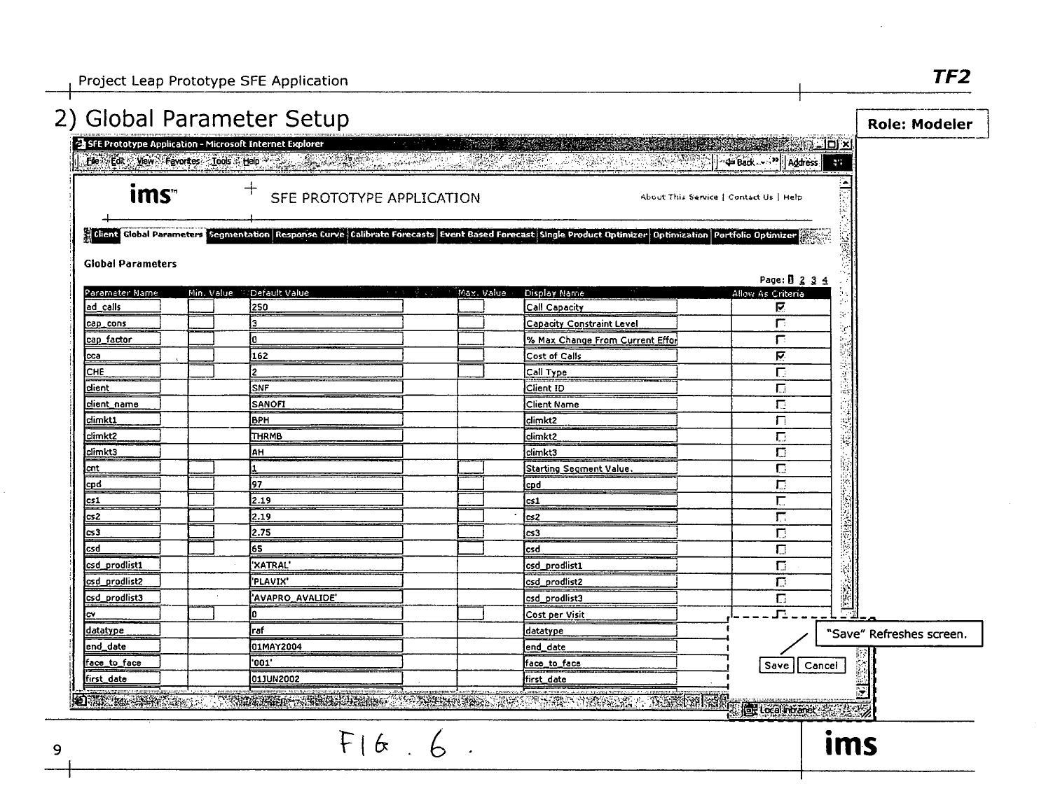

With reference to FIG. 4, screen display 401 provides the administrator with access to add and edit functions. These functions can respectively be used to enter client information (e.g., client identifiers and links to client specific data files, FIG. 5) and to edit a global parameters file (see e.g., FIG. 6) for subsequent processing by software application 300.

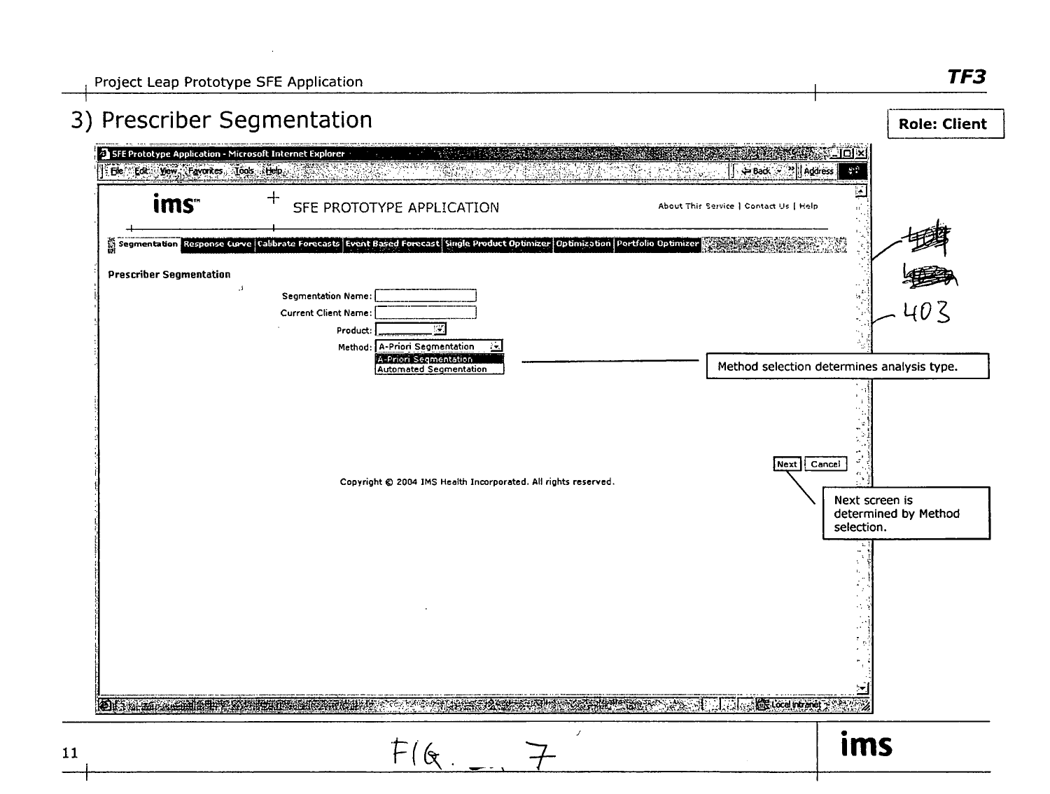

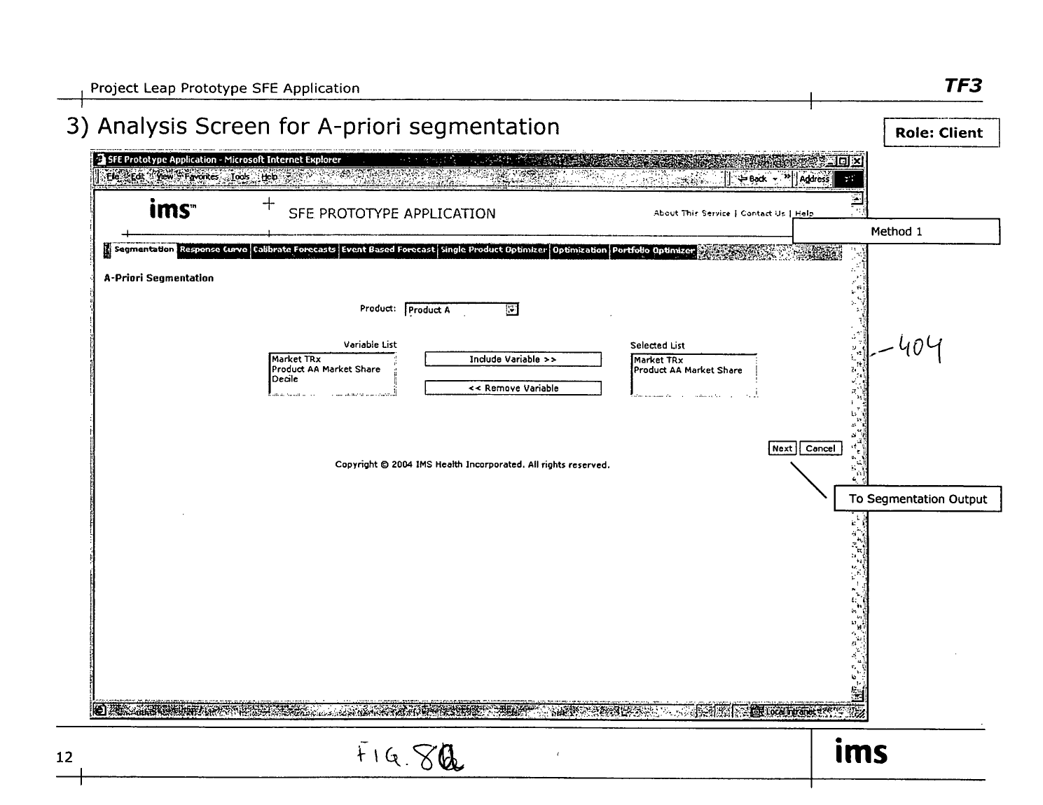

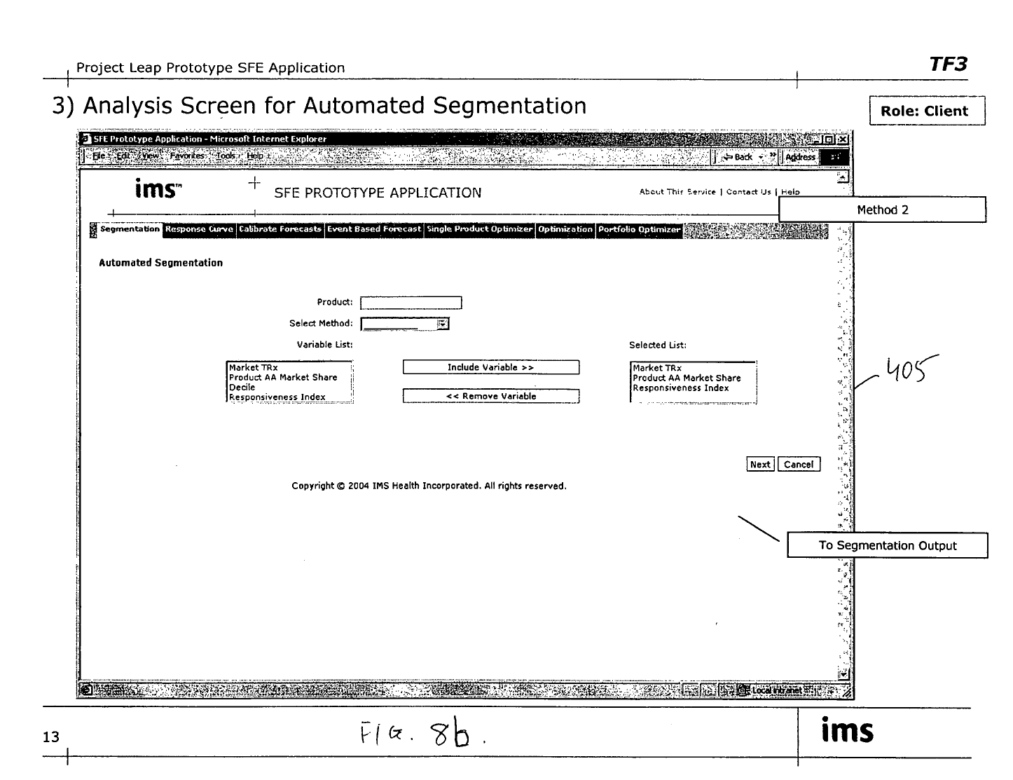

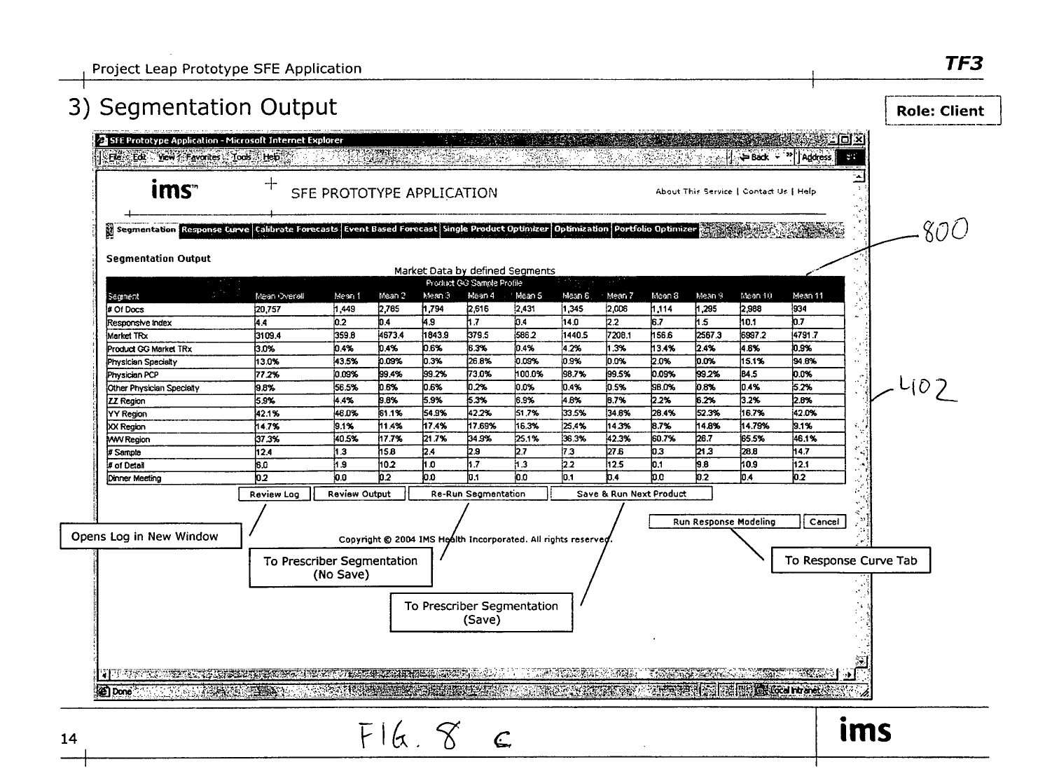

Next, a screen display 403 provides access to a prescriber segmentation tool, which can be activated by a user (client or administrator) to define market segments for a selected product marketed by the client. On screen display 403, the user may be offered a choice of methods for segment analysis, for example, an automated or an a-priori method (see FIG. 7). In case the automated method is selected, the user may choose a variable number of segments (e.g., up to 20 segments) for market segment analysis. In either method for segment analysis, the user may select the type of sales and market data variables (e.g., Market TRx, Product AA market share, Decile(volume), Responsive Index. etc.) on which the prescriber market segments should be based. (See e.g., FIGS. 8a and 8b). FIG. 8c shows a segmentation output screen display 402, which presents an exemplary output 800 of the segmentation tool to the user. Output 800 may, for example, be presented as a chart of market data by defined segments. The user may review the displayed segment definitions and elect to re-run the prescriber segmentation tool 403 (e.g., with a different set of variables) to obtain another set of segment definitions. Alternatively, the user can elect to accept and save the market segmentations definitions (output 800) for the selected product.

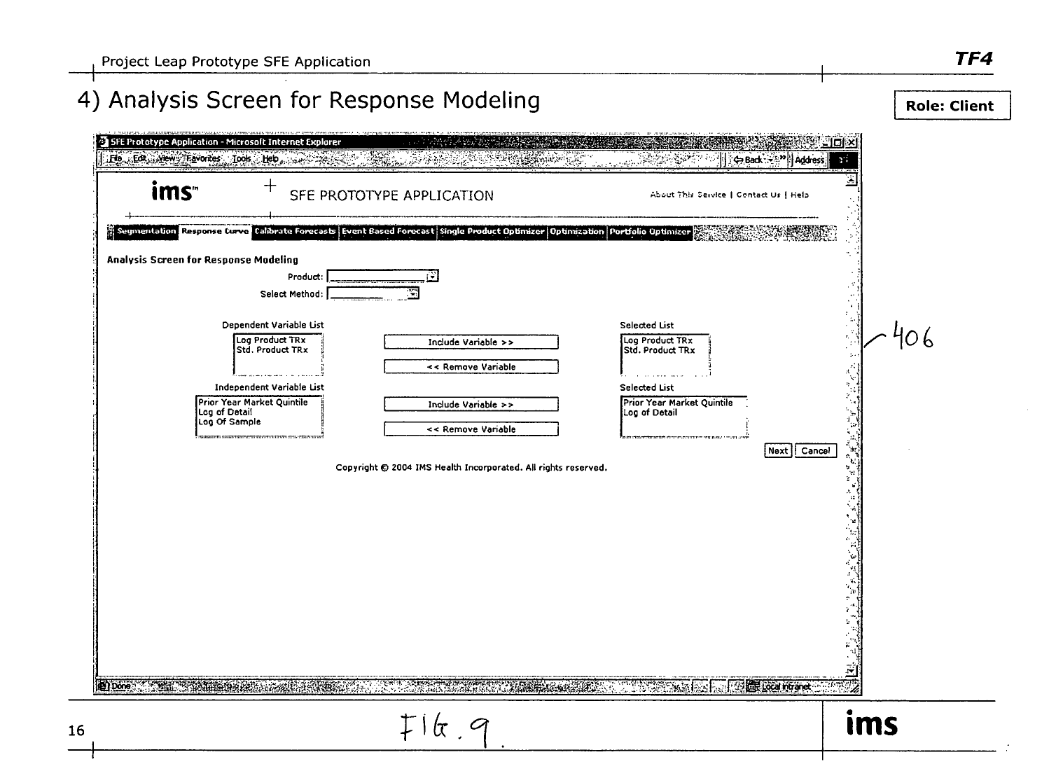

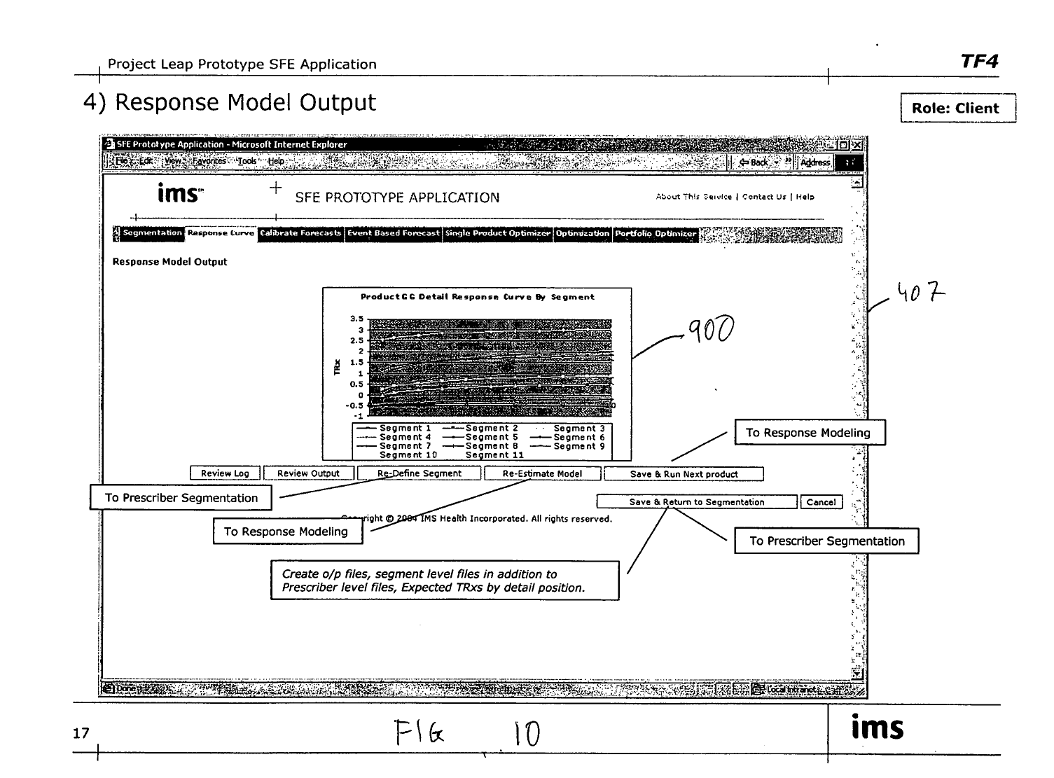

Next an analysis screen 406, which provides access to a response-modeling tool, may be presented to the user. The user may select dependent and independent variables for response modeling of the defined market segments (e.g., saved output 800) for the selected product. Screen 406 may allow the user to interactively select the dependent and the independent variables for the response curves generated by the response model (see FIG. 9). Response curves 900 generated by the response model are displayed on response model output screen 407 (see FIG. 10). Screen 407 may allow the user to review the generated response curves and to interactively choose to accept and save generated response curves 900, return to the previous response modeling screen 406 for reestimating response models, or return the previous prescribe segmentation screen 403 for redefining the prescriber market segments as desired.

Response model output screen 407 and segmentation output screen 402 also may respectively allow the user to re run the response model tool and the prescriber segmentation tool for another product, before proceeding to the next task in the sales force effectiveness analysis.

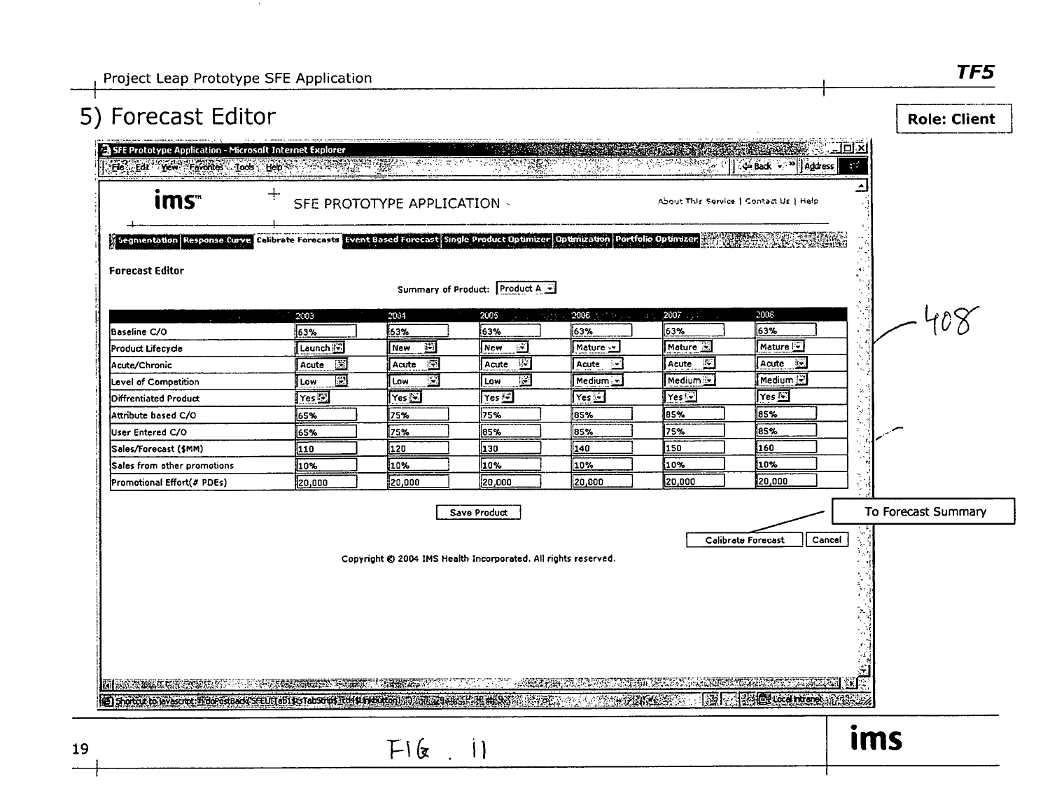

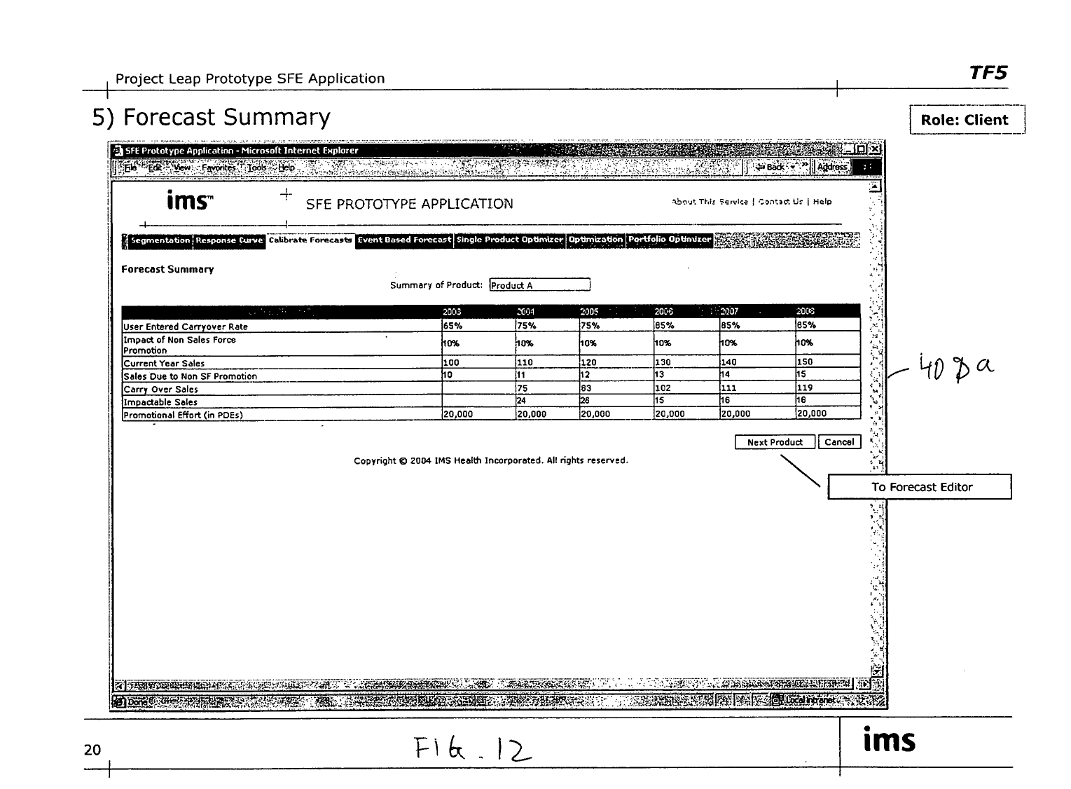

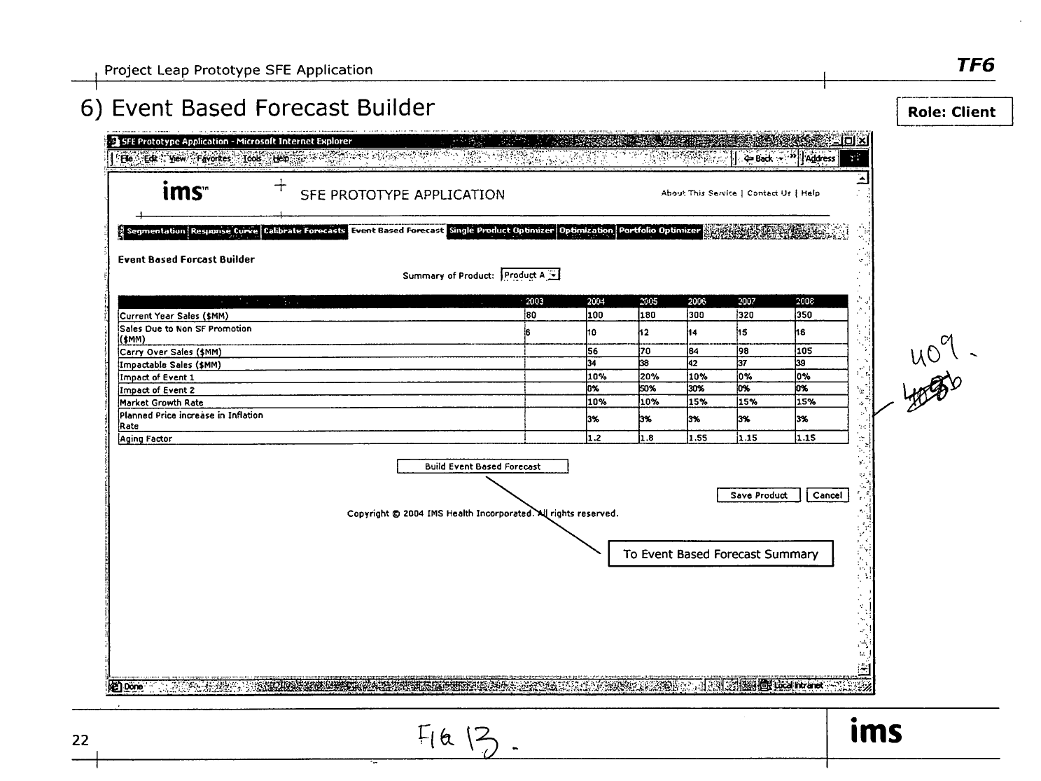

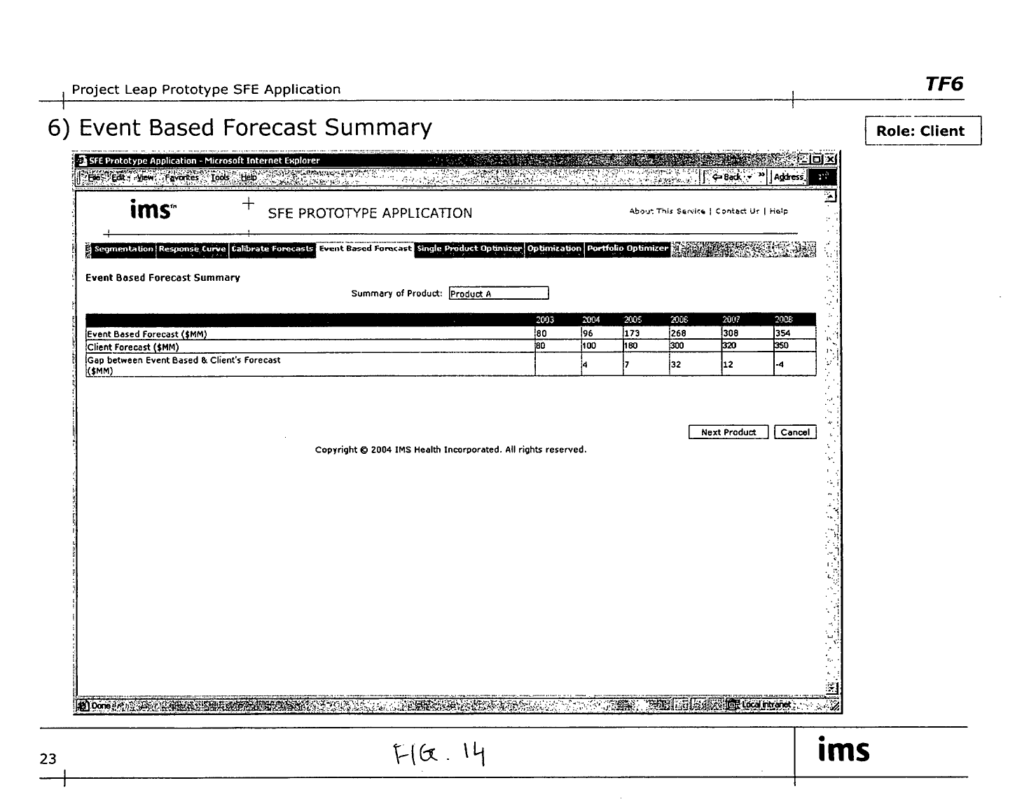

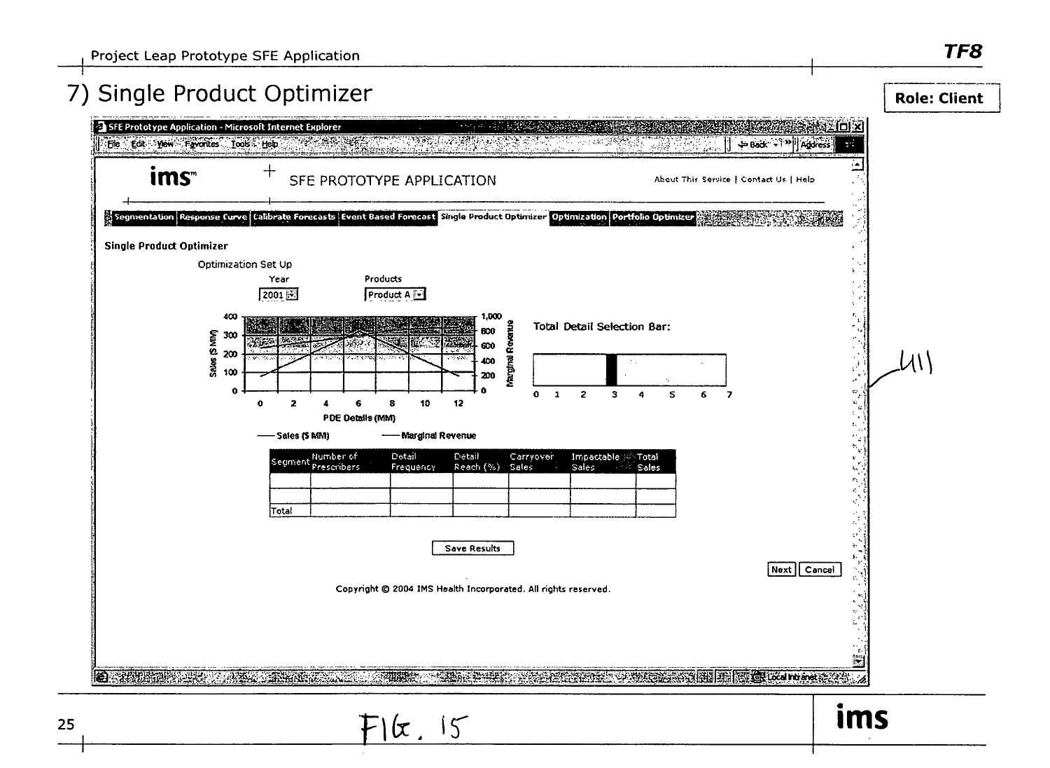

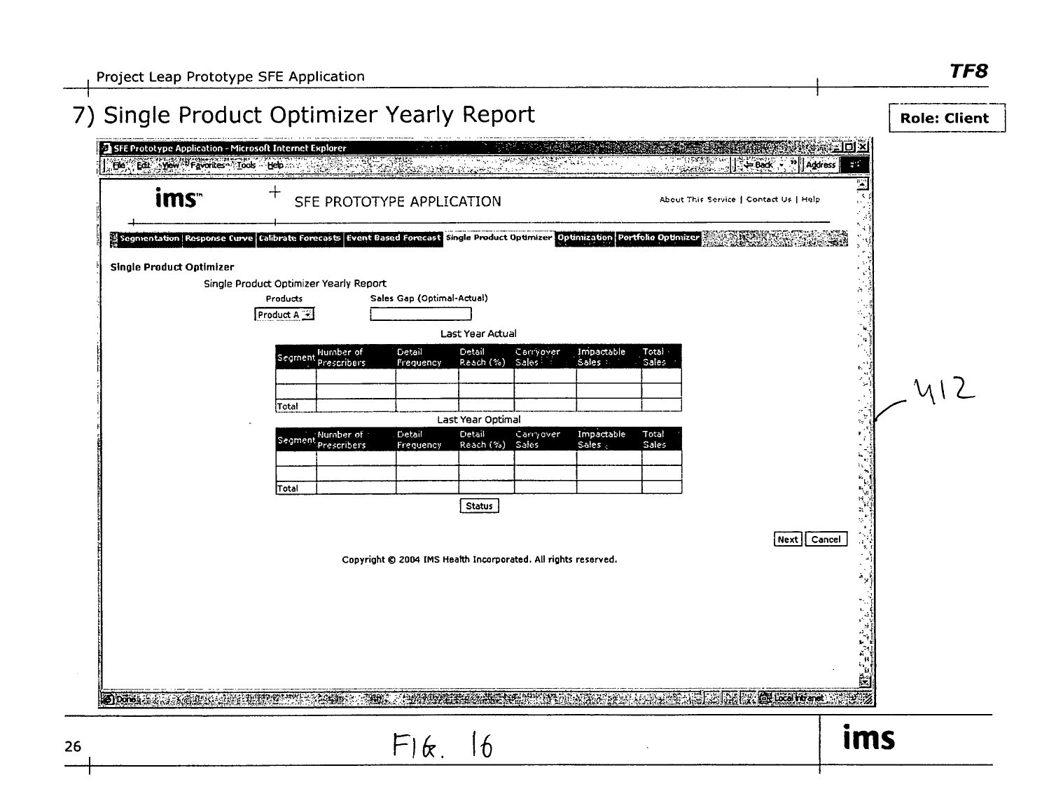

In preparation for running sales effort optimization algorithms, which act on the defined market segments (saved output 800) and segment response curves (saved response curves 900), screens 408 and 409 provide the user with access to a forecast editor tool (FIG. 11) and an event based forecast builder tool (FIG. 13). The user may use these screens to interactively generate sales/financial forecasts (using data and parameters specific to the client) and to calibrate such forecasts for each product of interest. The forecasts generated by the two tools are displayed on screens 408a and 410 (see FIGS. 12 and 14, respectively). In further preparation for running the sales effort optimization algorithms, optimization setup screen 411 (FIG. 15) may allow the user to generate reports on the financial impact (e.g., revenue, profit, NPV, and ROI) of the sales level for each product of interest to the client. The financial impact may be summarized in reports displayed on screens 412-414. (See e.g. FIGS. 16-18).

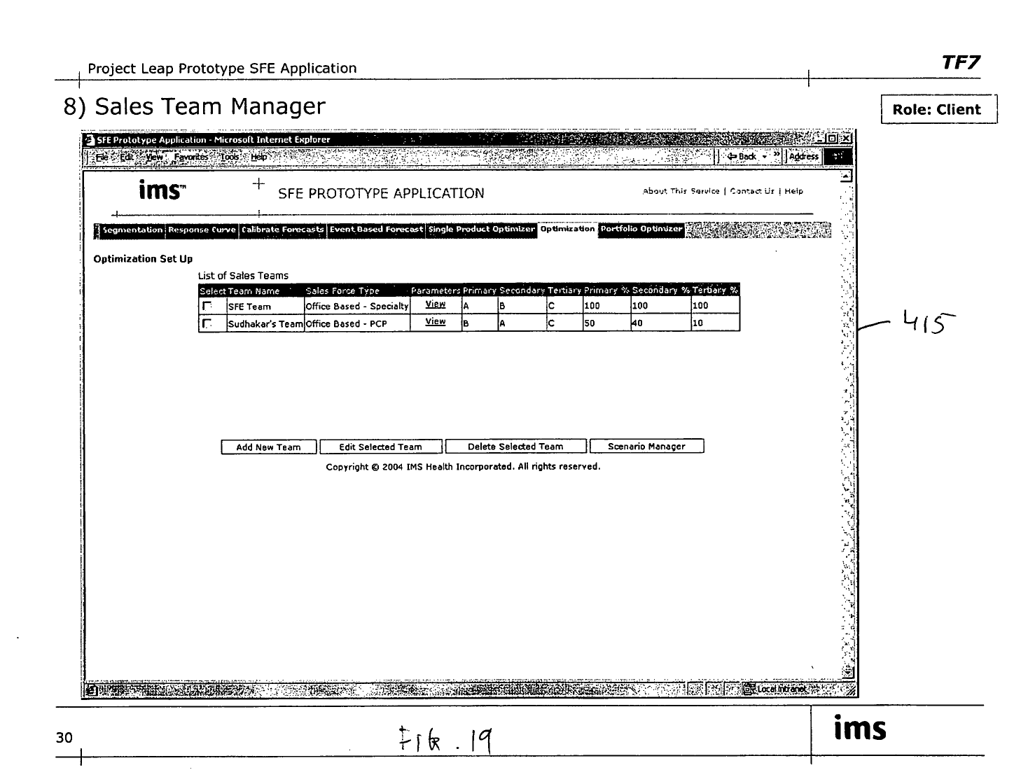

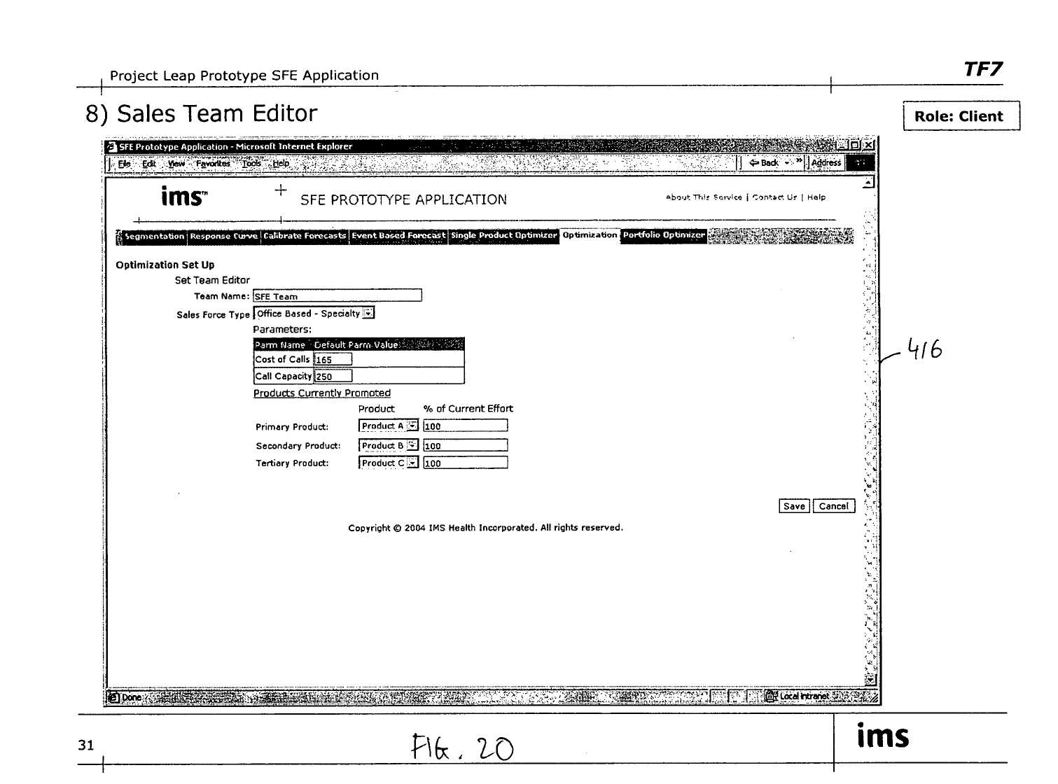

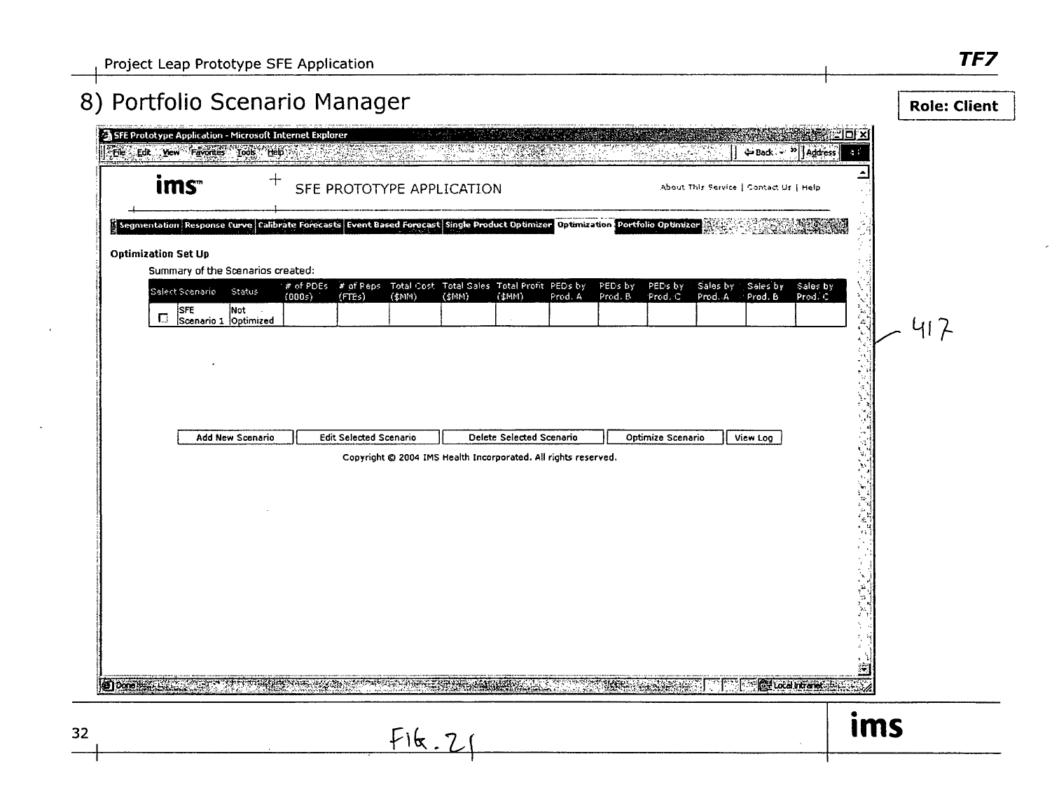

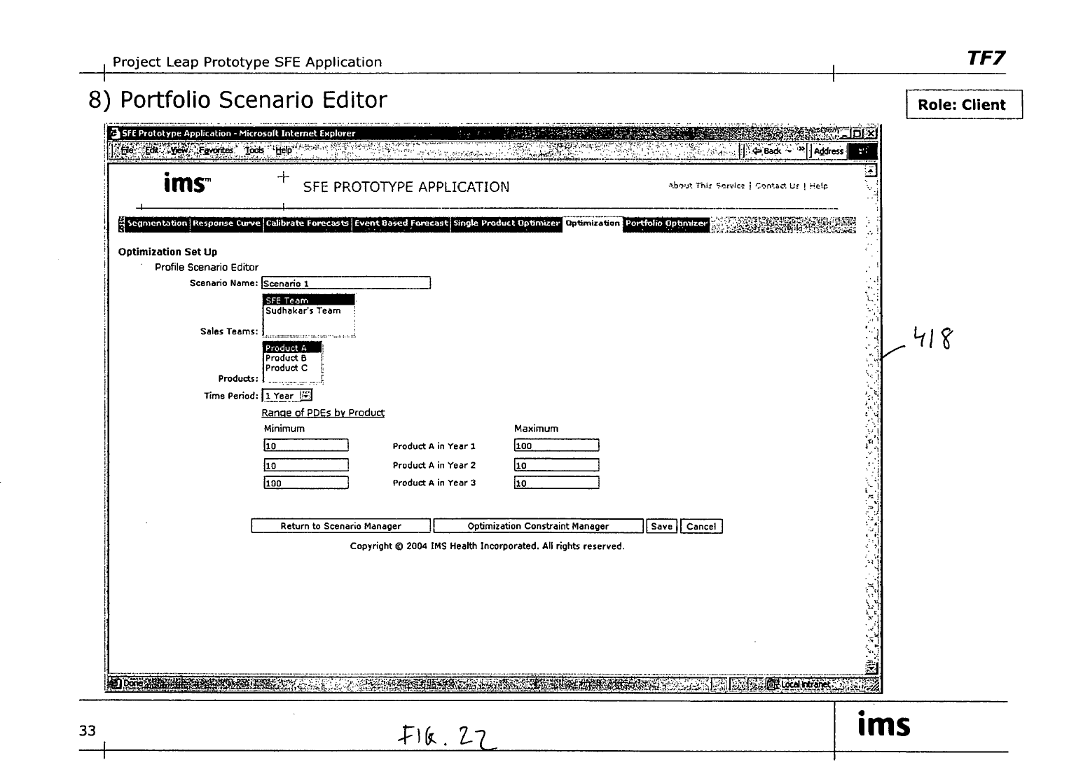

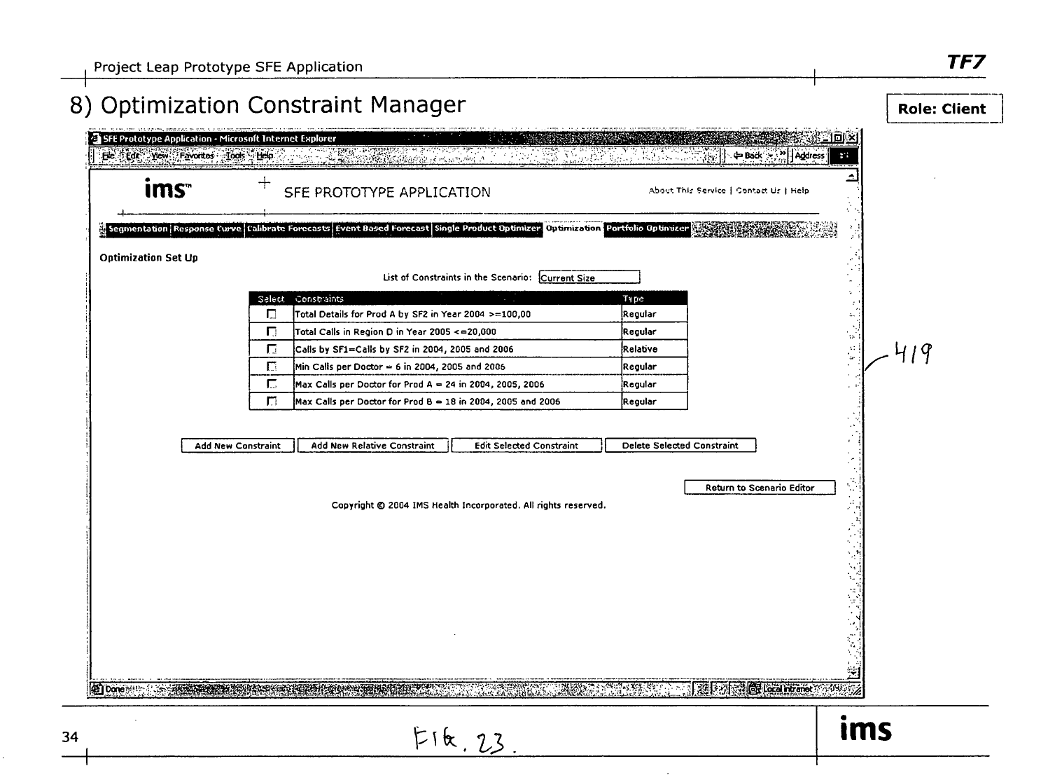

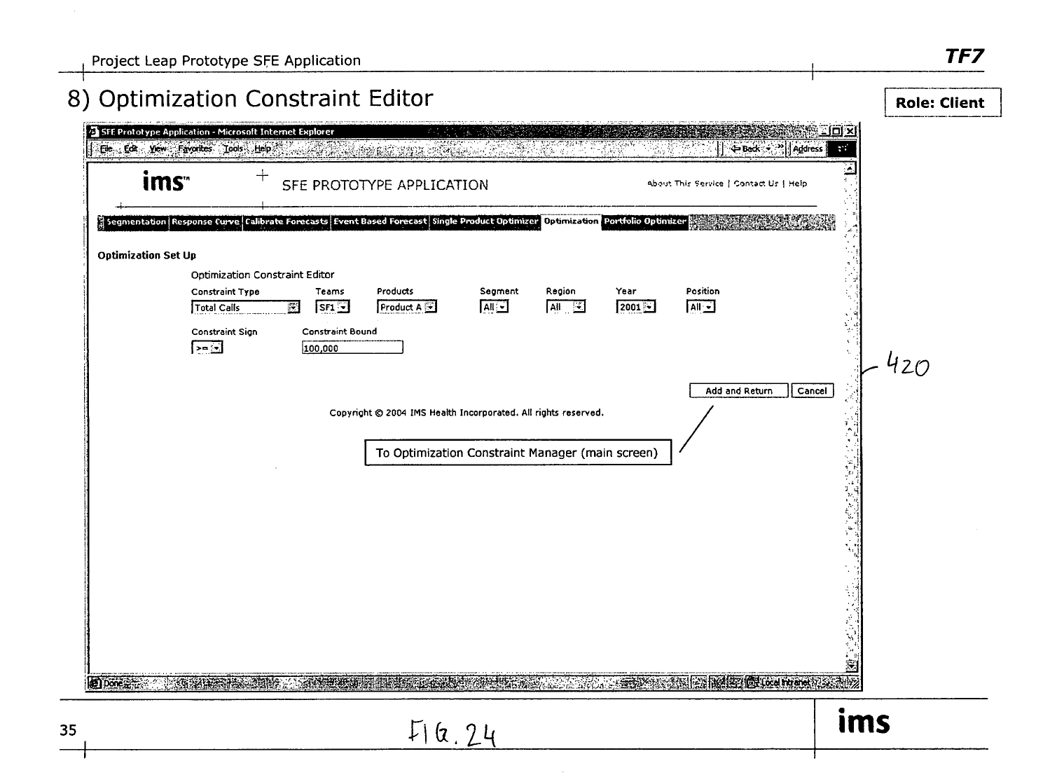

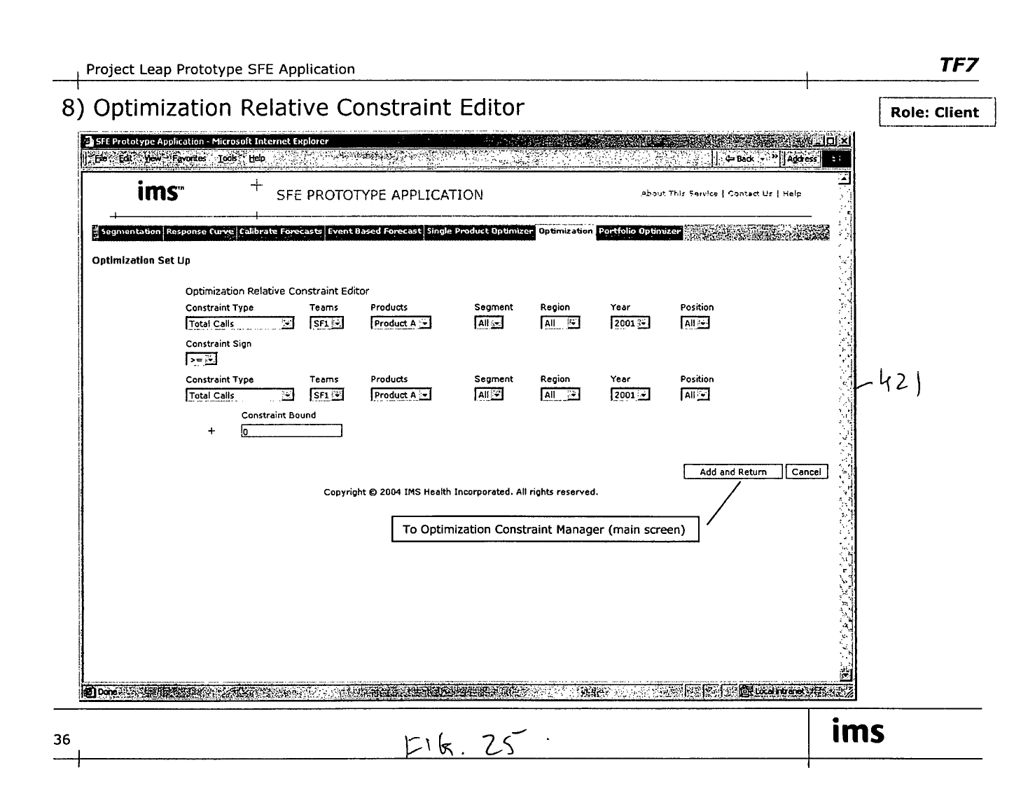

The next set of interactive screens 415-421 relate to software tools for setting up various operational and market scenarios for the sales activities for the selected product. Screens 415 and 416 provide access to an editor tool for designating a sales team for the sales effort. (See FIGS. 19 and 20). A screen 418 (FIG. 22) provides the user access to a scenario profiling tool for developing named sales activity scenarios, which are then displayed or listed on screen 417 (FIG. 21). The scenarios developed by the scenario profiling tool may be subject to one or more optimization constraints selected from a list of constraints displayed on screen 419 (FIG. 23). Exemplary optimization constraints may be physical or resource limitations (e.g., the maximum number of calls that a sales team can physically make, etc.) or business rules. The list of constraints displayed on screen 419 for selection may be interactively modified by the user via screens 420 and 421. These latter screens provide the user with access to a constraint editor tool and a relative constraint editor tool, respectively. (See FIGS. 24 and 25).

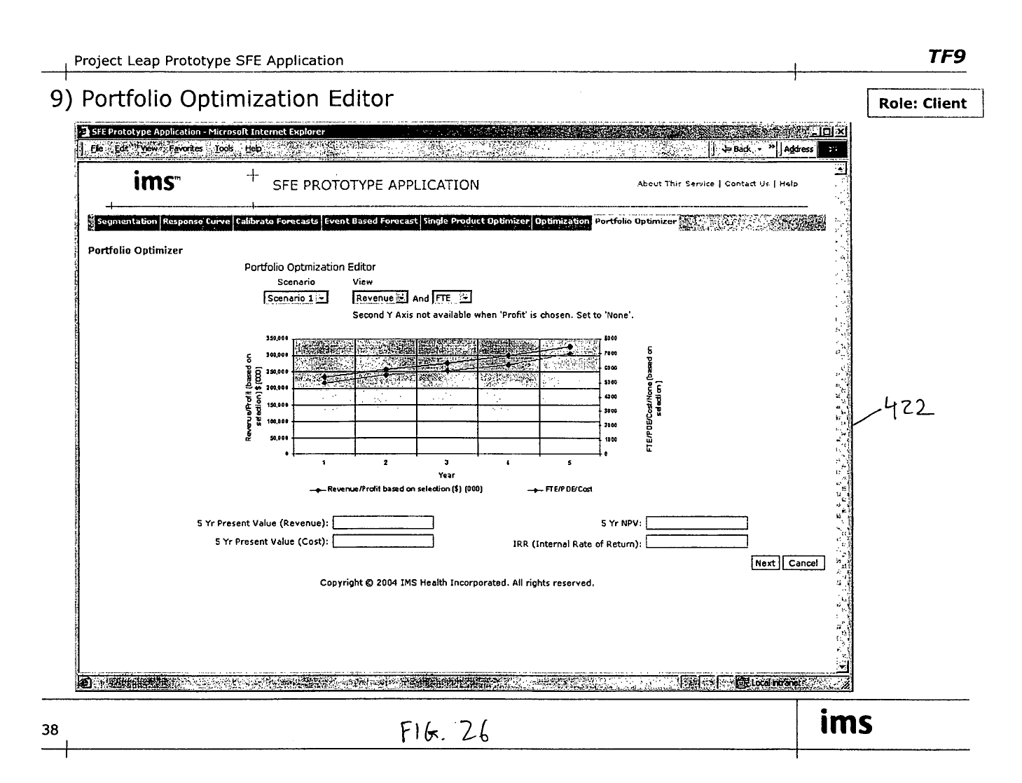

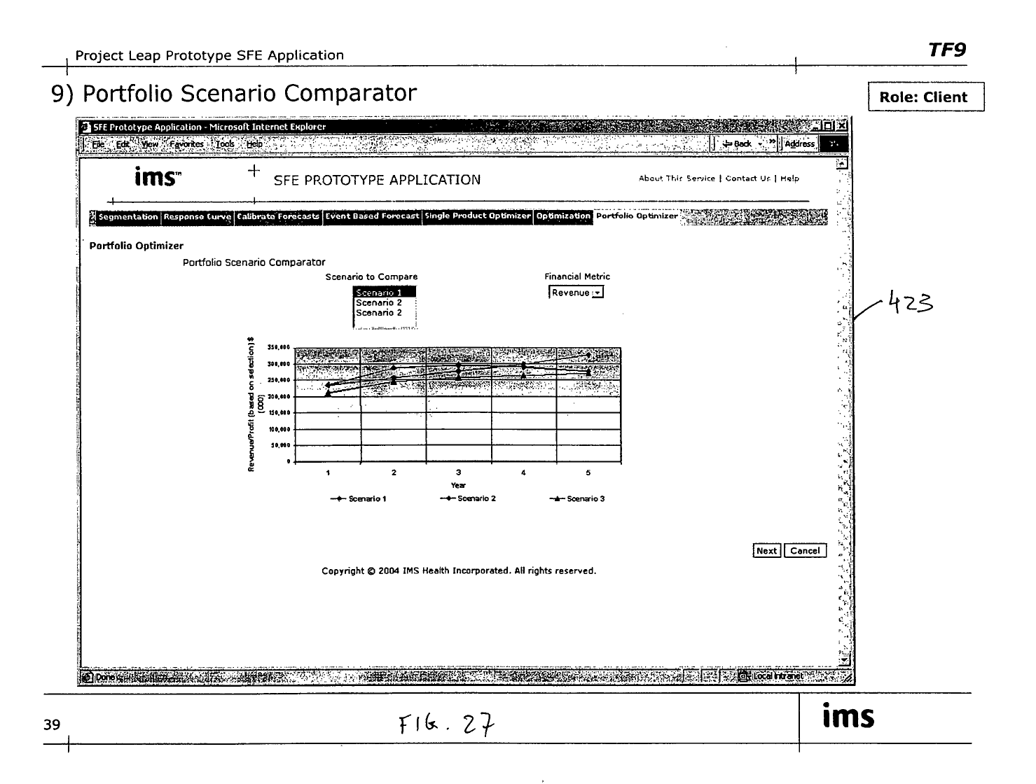

Selected sales activity scenarios for a selected sales team and selected product may then be optimized subject to selected constraints with a portfolio optimization tool. The portfolio optimization tool may be activated by a user via screen 422. (See FIG. 26). Screen 422 provides the user with links to display screens 423-426, which display the results of the optimization algorithms of the portfolio optimization tool. For example, comparator screen 423 provides comparative displays of selected financial metrics for different selected scenarios. Screens 424 and 425 may display portfolio optimization reports with varying levels of detail (e.g., by scenario, product, year, etc. ). Screen 426 may provide a financial summary report. (See FIGS. 27-30).

In accordance with the invention, a business planning solution implemented for sales force effectiveness using software application 300 (or similar tool sets) advantageously provides the entity with planning assessments of the required size of an effective sale force and the financial/resource implications of such a sale force. The business planning solution can optimize allocation of sales and marketing resources across a portfolio of products. Financial impacts of changes in resource levels and allocations can be pre-assessed, for example, by product brand or sales channel. The business planning solution also may provide analysis of the impact of market constraints such as a licensing agreement, which may affect sales activities. The business planning solution can provide detailed sales call plans for sales force effectiveness. The sales call plans may provide detailed instructions, for example, specifying which optimal selection of products, by market position, should each individual sales person promote to which individual sales targets (e.g., prescriber or physician).

In accordance with the present invention, software (i.e., instructions) for implementing the aforementioned business planning solution for sales force effectiveness can be provided on computer-readable media. It will be appreciated that each of the steps (described above in accordance with this invention), and any combination of these steps, can be implemented by computer program instructions. These computer program instructions can be loaded onto a computer or other programmable apparatus to produce a machine, such that the instructions, which execute on the computer or other programmable apparatus create means for implementing the functions of the aforementioned business planning solution for sales force effectiveness. These computer program instructions can also be stored in a computer-readable memory that can direct a computer or other programmable apparatus to function in a particular manner, such that the instructions stored in the computer-readable memory produce an article of manufacture including instruction means which implement the functions of the aforementioned innervated stochastic controllers and systems. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the functions of aforementioned business planning solution for sales force effectiveness. It will also be understood that the computer-readable media on which instructions for implementing the aforementioned business planning solutions are provided, include without limitation, firmware, micro controllers, microprocessors, integrated circuits, ASICS, and other available media.

It will be understood, further, that the foregoing is only illustrative of the principles of the invention, and that various modifications can be made by those skilled in the art, without departing from the scope and spirit of the invention, which is limited only by the claims that follow.

1. A business planning solution for an entity promoting sales of pharmaceutical products in a target market of prescribers, comprising the steps of:
(a) conducting market segmentation analysis based on pharmaceutical sales and market data;
(b) identifying a set of market segments;
(c) developing market response curves for the identified market segments;
(d) based on the market response curves, optimizing the entity's resource allocations for sales activities in individual segments of the set of market segments toward achieving a sales goal for a particular product.

2. The business planning solution of claim 1 wherein in step (a) the pharmaceutical sales and market data comprises volume and shares data for each prescriber and product combination.

3. The business planning solution of claim 1 wherein in step (a) the pharmaceutical sales and market data comprises demographic data related to the target market of prescribers.

4. The business planning solution of claim 1 wherein in step (c) developing the market response curves for the identified market segments comprises using an empirical response model based on prior market response data.

5. The business planning solution of claim 1 wherein step (d) the optimization of the entity's resource allocations is subject to market constraints.

6. The business planning solution of claim 1 wherein step (d) the optimization of the entity's resource allocations is subject to the entity's sales activity constraints.

7. The business planning solution of claim 1 wherein step (d) the optimization of the entity's resource allocations comprises a sales call plan for promoting the pharmaceutical products in the target market of prescribers.

8. The business planning solution of claim 1, further comprising a step (e) of generating sales and market scenarios and optimizing the entity's resource allocations for selected scenarios.

9. The business planning solution of claim 1 further comprising a step (f) of conducting portfolio segmentation analysis across a market mix of products promoted by the entity, and wherein step (e) further comprises optimizing the entity's resource allocations for sales activities in individual segments of the set of market segments toward achieving sales goals for the mix for products.

10. The business planning solution of claim 1, implemented as a software arrangement on computer-readable media.

11. A software application for optimizing the sales activities of an entity promoting pharmaceutical products in a target market, the software application, comprising:
a tool for identifying a set of market segments by segmentation analysis of the target market based on pharmaceutical sales and market data;
a tool for generating market response curves for the sale of a particular product in identified market segments;
a tool for optimizing the entity's resource allocations for sales activities in individual segments of the set of identified market segments according to their market response curves toward achieving sales goals for a particular product.

12. The software application of claim 11 configured with an interface for electronic receipt of the pharmaceutical sales and market data.

13. The software application of claim 11 which is customizable to the business characteristics of a specific entity.

14. The software application of claim 11 further comprising a forecasting tool for generating forecasts that are used to define the sales goals.

15. The software application of claim 11 further comprising a profile scenario editor for generating sales and market activity scenarios.

16. The software application of claim 15 further comprising an optimization constraint editor for generating sales and market constraints on the scenarios of claim 14.

17. The software application of claim 15 wherein the tool for optimizing the entity's resource allocations is configured to generate optimal resource allocations for a user-selected scenario.

18. The software application of claim 17 wherein the tool for optimizing the entity's resource allocations is configured to generate sales call plans for a user-selected sales team.

19. The software application of claim 11 further configured for portfolio segmentation analysis of a mix of products marketed by the entity, and wherein the tool for optimizing the entity's resource allocations is further configured to generate optimal resource allocations for sales activities promoting the mix of products towards sales goals.

20. The software application of claim 11 further comprising interfaces for interactive operation of the software application by a user.
